(19) United States
(12) Patent Application Publication
(10) Pub. No.: US 2025/0024344 A1
(43) Pub. Date: Jan. 16, 2025

(54) COMMUNICATIONS DEVICE, INFRASTRUCTURE EQUIPMENT AND METHODS

(71) Applicant: Sony Group Corporation, Tokyo (JP)

(72) Inventors: Yuxin WEI, Basingstoke (GB); Vivek SHARMA, Basingstoke (GB); Hideji WAKABAYASHI, Basingstoke (GB); Yassin Aden AWAD, Basingstoke (GB)

(73) Assignee: Sony Group Corporation, Tokyo (JP)

(21) Appl. No.: 18/713,512

(22) PCT Filed: Dec. 1, 2022
(86) PCT No.: PCT/EP2022/084004

§ 371 Date: May 24, 2024

(30) Foreign Application Priority Data
Dec. 8, 2021 (EP) 21213229.4

(51) Int. Cl. H04W 36/36; H04W 36/00

(52) U.S. Cl. CPC H04W 36/362; H04W 36/033

(57) ABSTRACT

A method comprising receiving, by a communications device from a wireless communications network, one or more conditions for triggering a handover of the communications device to a target infrastructure equipment and one or more conditions for triggering a handover of the communications device to a target communications device configured to relay signals between the communications device and the wireless communications network. The method comprises evaluating the one or more conditions for triggering the handover to the target infrastructure equipment and the one or more conditions for triggering the handover to the target relay communications device. The method comprises initiating the handover to the target infrastructure equipment or the target relay communications device based on the evaluation of the one or more conditions for triggering the handover to the target infrastructure equipment and the one or more conditions for triggering the handover to the target relay communications device.

### BACKGROUND

### Field

The present disclosure relates to a method of operating a communications device for transmitting signals to and/or receiving signals from a wireless communications network.

The present application claims the Paris Convention priority of European patent application number EP21213229.4, the contents of which are hereby incorporated by reference in their entirety.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present invention.

Third and fourth generation mobile telecommunication systems, such as those based on the 3GPP defined UMTS and Long Term Evolution (LTE) architecture, are able to support more sophisticated services than simple voice and messaging services offered by previous generations of mobile telecommunication systems. For example, with the improved radio interface and enhanced data rates provided by LTE systems, a user is able to enjoy high data rate applications such as mobile video streaming and mobile video conferencing that would previously only have been available via a fixed line data connection. The demand to deploy such networks is therefore strong and the coverage area of these networks, i.e. geographic locations where access to the networks is possible, may be expected to increase ever more rapidly.

Future wireless communications networks will be expected to support communications routinely and efficiently with a wider range of devices associated with a wider range of data traffic profiles and types than current systems are optimised to support. For example, it is expected future wireless communications networks will be expected to support efficiently communications with devices including reduced complexity devices, machine type communication (MTC) devices, high resolution video displays, virtual reality headsets and so on. Some of these different types of devices may be deployed in very large numbers, for example low complexity devices for supporting the “The Internet of Things”, and may typically be associated with the transmissions of relatively small amounts of data with relatively high latency tolerance.

In view of this there is expected to be a desire for future wireless communications networks, for example those which may be referred to as 5G or new radio (NR) system/new radio access technology (RAT) systems [1], as well as future iterations/releases of existing systems, to efficiently support connectivity for a wide range of devices associated with different applications and different characteristic data traffic profiles. The connectivity of devices is conventionally maintained through the use of so-called “handover” procedures where a communications device changes its access point to a wireless communications network in response to an instruction from the wireless communications network or in response to one or more conditions being met. In view of the wide range device types and capabilities in future wireless communications networks, there is a need for improved handover procedures.

### SUMMARY

The present disclosure can help address or mitigate at least some of the issues discussed above.

Example embodiments of the present technique can provide a method of operating a communications device to transmit and/or to receive signals from a wireless communications network. The method comprises receiving, by the communications device from the wireless communications network, one or more conditions for triggering a handover of the communications device to a target infrastructure equipment of the wireless communications network and one or more conditions for triggering a handover of the communications device to a target communications device configured to relay signals between the communications device and the wireless communications network. The method comprises evaluating the one or more conditions for triggering the handover to the target infrastructure equipment and the one or more conditions for triggering the handover to the target relay communications device. The method comprises initiating the handover to the target infrastructure equipment or the target relay communications device based on the evaluation of the one or more conditions for triggering the handover to the target infrastructure equipment and the one or more conditions for triggering the handover to the target relay communications device.

Embodiments can therefore provide improved handover procedures in a wireless communications network and, in particular, embodiments can enable a communications device to select between handing over to an infrastructure equipment or a relay communications device as candidate targets for the handover.

Respective aspects and features of the present disclosure are defined in the appended claims.

It is to be understood that both the foregoing general description and the following detailed description are exemplary, but are not restrictive, of the present technology. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein like reference numerals designate identical or corresponding parts throughout the several views, and:

FIG. 1 schematically represents some aspects of an LTE-type wireless telecommunication system which may be configured to operate in accordance with certain embodiments of the present disclosure;

FIG. 2 schematically represents some aspects of a new radio access technology (RAT) wireless telecommunications system which may be configured to operate in accordance with certain embodiments of the present disclosure;

FIG. 3 is a schematic block diagram of an example of a source infrastructure equipment controlling handover of a communications device to a target infrastructure equipment;

FIG. 4 schematically represents a conventional conditional handover procedure;

FIG. 5A schematically represents a wireless communications network in which a communications device is handed over from a source infrastructure equipment to a target infrastructure equipment or target relay communications device according to example embodiments;

FIG. 5B schematically represents a wireless communications network in which a communications device is handed over from a source relay communications device to a target infrastructure equipment or target relay communications device according to example embodiments;

FIG. 6 is a flow diagram representing steps performed by a communications device to be handed over to a target infrastructure equipment or target relay communications device according to example embodiments.

### DETAILED DESCRIPTION OF THE EMBODIMENTS

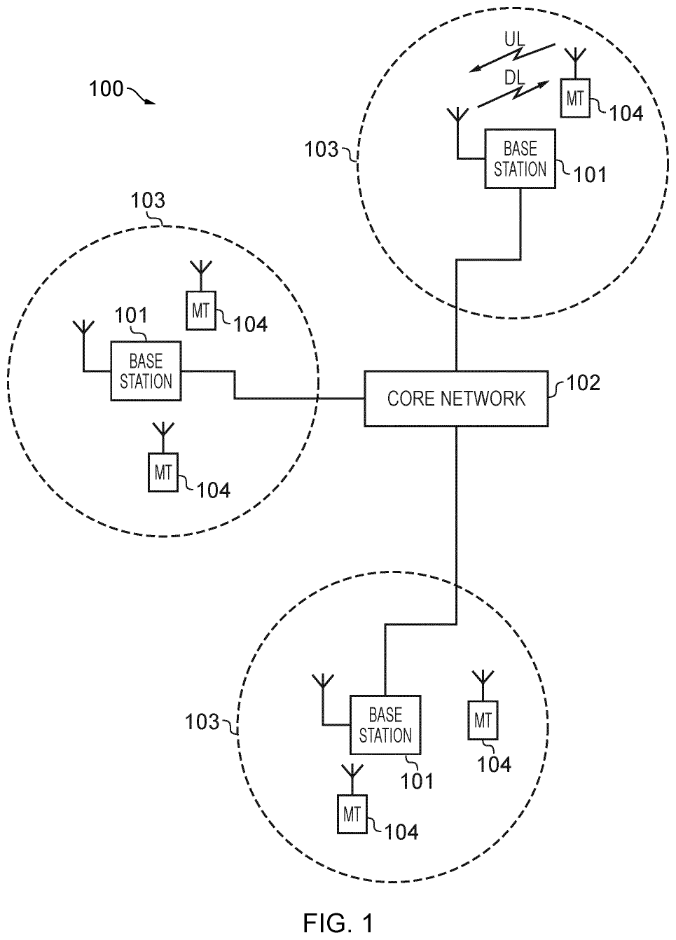

Long Term Evolution Advanced Radio Access Technology (4G) FIG. 1 provides a schematic diagram illustrating some basic functionality of a mobile telecommunications network/system 100 operating generally in accordance with LTE principles, but which may also support other radio access technologies, and which may be adapted to implement embodiments of the disclosure as described herein. Various elements of FIG. 1 and certain aspects of their respective modes of operation are well-known and defined in the relevant standards administered by the 3GPP (RTM) body, and also described in many books on the subject, for example, Holma H. and Toskala A [2]. It will be appreciated that operational aspects of the telecommunications networks discussed herein which are not specifically described (for example in relation to specific communication protocols and physical channels for communicating between different elements) may be implemented in accordance with any known techniques, for example according to the relevant standards and known proposed modifications and additions to the relevant standards.

The network 100 includes a plurality of base stations 101 connected to a core network part 102. Each base station provides a coverage area 103 (e.g. a cell) within which data can be communicated to and from communications devices 104. Data is transmitted from the base stations 101 to the communications devices 104 within their respective coverage areas 103 via a radio downlink. Data is transmitted from the communications devices 104 to the base stations 101 via a radio uplink. The core network part 102 routes data to and from the communications devices 104 via the respective base stations 101 and provides functions such as authentication, mobility management, charging and so on. Communications devices may also be referred to as mobile stations, user equipment (UE), user terminals, mobile radios, terminal devices, and so forth. Base stations, which are an example of network infrastructure equipment/network access nodes, may also be referred to as transceiver stations/nodeBs/e-nodeBs, g-nodeBs (gNB) and so forth. In this regard different terminology is often associated with different generations of wireless telecommunications systems for elements providing broadly comparable functionality. However, example embodiments of the disclosure may be equally implemented in different generations of wireless telecommunications systems such as 5G or new radio as explained below, and for simplicity certain terminology may be used regardless of the underlying network architecture. That is to say, the use of a specific term in relation to certain example implementations is not intended to indicate these implementations are limited to a certain generation of network that may be most associated with that particular terminology.

### New Radio Access Technology (5G)

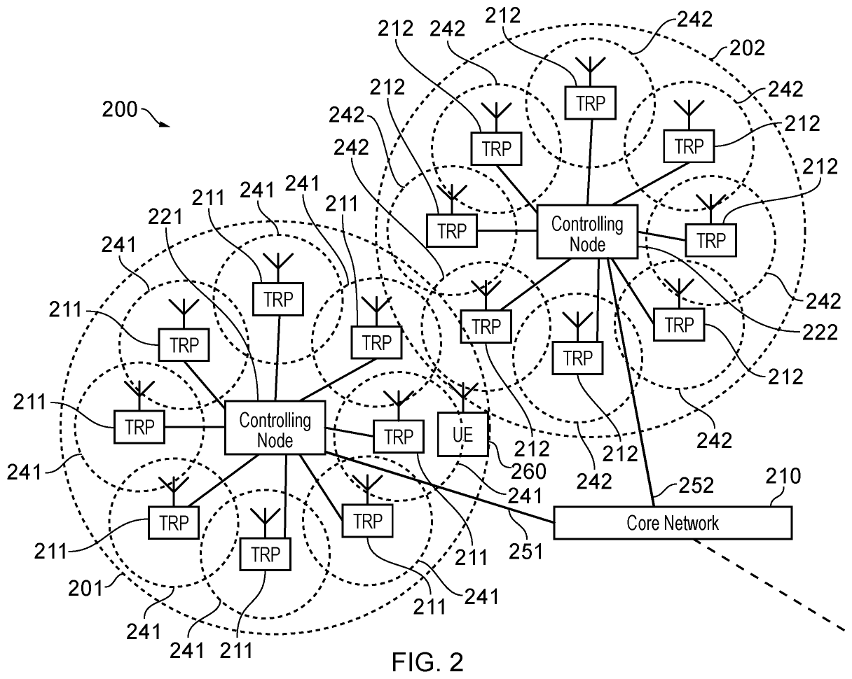

FIG. 2 is a schematic diagram illustrating a network architecture for a new RAT wireless communications network/system 200 based on previously proposed approaches which may also be adapted to provide functionality in accordance with embodiments of the disclosure described herein. The new RAT network 200 represented in FIG. 2 comprises a first communication cell 201 and a second communication cell 202. Each communication cell 201, 202, comprises a controlling node (centralised unit) 221, 222 in communication with a core network component 210 over a respective wired or wireless link 251, 252. The respective controlling nodes 221, 222 are also each in communication with a plurality of distributed units (radio access nodes/remote transmission and reception points (TRPs)) 211, 212 in their respective cells. Again, these communications may be over respective wired or wireless links. The distributed units 211, 212 are responsible for providing the radio access interface for communications devices connected to the network. Each distributed unit 211, 212 has a coverage area (radio access footprint) 241, 242 where the sum of the coverage areas of the distributed units under the control of a controlling node together define the coverage of the respective communication cells 201, 202. Each distributed unit 211, 212 includes transceiver circuitry for transmission and reception of wireless signals and processor circuitry configured to control the respective distributed units 211, 212.

In terms of broad top-level functionality, the core network component 210 of the new RAT communications network represented in FIG. 2 may be broadly considered to correspond with the core network 102 represented in FIG. 1, and the respective controlling nodes 221, 222 and their associated distributed units/TRPs 211, 212 may be broadly considered to provide functionality corresponding to the base stations 101 of FIG. 1. The term network infrastructure equipment/access node may be used to encompass these elements and more conventional base station type elements of wireless communications systems. Depending on the application at hand the responsibility for scheduling transmissions which are scheduled on the radio interface between the respective distributed units and the communications devices may lie with the controlling node/centralised unit and/or the distributed units/TRPs.

A communications device or UE 260 is represented in FIG. 2 within the coverage area of the first communication cell 201. This communications device 260 may thus exchange signalling with the first controlling node 221 in the first communication cell via one of the distributed units 211 associated with the first communication cell 201. In some cases communications for a given communications device are routed through only one of the distributed units, but it will be appreciated that in some other implementations communications associated with a given communications device may be routed through more than one distributed unit, for example in a soft handover scenario and other scenarios.

In the example of FIG. 2, two communication cells 201, 202 and one communications device 260 are shown for simplicity, but it will of course be appreciated that in practice the system may comprise a larger number of communication cells (each supported by a respective controlling node and plurality of distributed units) serving a larger number of communications devices.

It will further be appreciated that FIG. 2 represents merely one example of a proposed architecture for a new RAT communications system in which approaches in accordance with the principles described herein may be adopted, and the functionality disclosed herein may also be applied in respect of wireless communications systems having different architectures.

Thus example embodiments of the disclosure as discussed herein may be implemented in wireless telecommunication systems/networks according to various different architectures, such as the example architectures shown in FIGS. 1 and 2. It will thus be appreciated that the specific wireless communications architecture in any given implementation is not of primary significance to the principles described herein. In this regard, example embodiments of the disclosure may be described generally in the context of communications between network infrastructure equipment/access nodes and a communications device, wherein the specific nature of the network infrastructure equipment/access node and the communications device will depend on the network infrastructure for the implementation at hand. For example, in some scenarios the network infrastructure equipment/access node may comprise a base station, such as an LTE-type base station 101 as shown in FIG. 1 which is adapted to provide functionality in accordance with the principles described herein, and in other examples the network infrastructure equipment/access node may comprise a control unit/controlling node 221, 222 and/or a TRP 211, 212 of the kind shown in FIG. 2 which is adapted to provide functionality in accordance with the principles described herein.

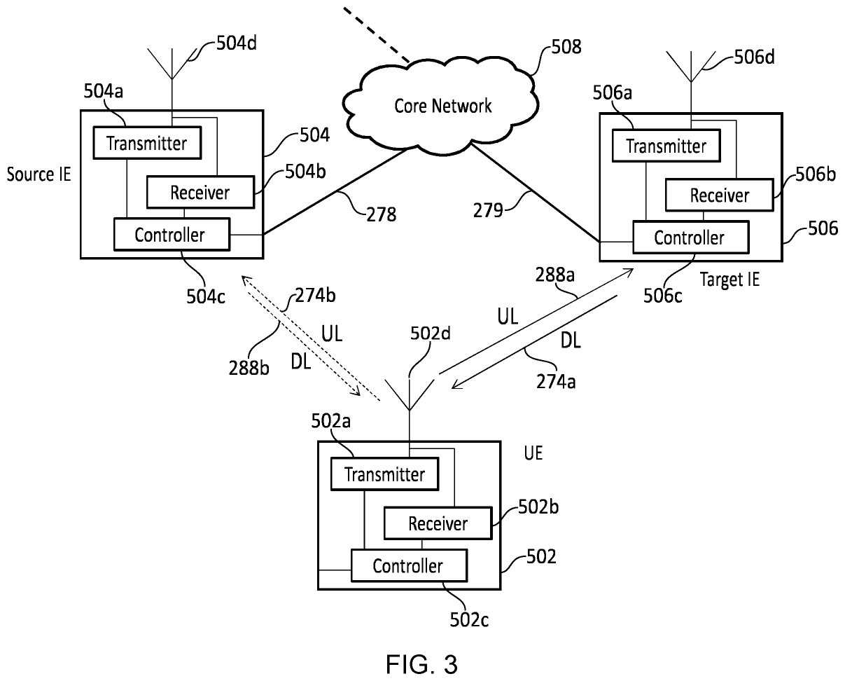

A detailed illustration of a wireless communications network in which a handover may be performed is shown in FIG. 3. As will be appreciated from FIG. 3, a communications device 502 is handed over from a source infrastructure equipment 504 to a target infrastructure equipment 506 forming part of a radio access network to a core network 508. As will be appreciated the communications device 502 is an example of a communications device such as the communications device 260 of FIG. 2. The communications device 502 may be a UE in one example.

Before the handover, the communications device 502 transmits signals on an uplink UL and receive signals on a downlink DL from a source infrastructure equipment 504. The source infrastructure equipment 504 and the target infrastructure equipment 506 may each be thought of as a gNB 101 or a combination of a controlling node 221 and TRP 211. Before the handover, the communications device 502 is shown to transmit uplink data to the source infrastructure equipment 504 via uplink resources UL of a wireless access interface as illustrated generally by dashed arrow 274b to the source infrastructure equipment 504. The communications device 502 may similarly be configured to receive downlink data transmitted by the source infrastructure equipment 504 via downlink resources DL as indicated by dashed arrow 288b from the source infrastructure equipment 504 to the communications device 502. After the handover, the communications device 502 is shown to transmit uplink data to the target infrastructure equipment 506 via uplink resources UL of a wireless access interface as illustrated generally by solid arrow 288a to the target infrastructure equipment 506. The communications device 502 may similarly be configured to receive downlink data transmitted by the target infrastructure equipment 506 via downlink resources DL as indicated by solid arrow 274a from the target infrastructure equipment 506 to the communications device 502.

In FIG. 3, the source and target infrastructure equipment 504, 506 are each connected to a core network 508 via interfaces 278, 279 to a controller 504c, 506c of the respective infrastructure equipment 504. The source and target infrastructure equipment 504, 506 each include a receiver 504b, 506b connected to an antenna 504d, 506d and a transmitter 504a, 506a connected to the antenna 504d, 506d. Correspondingly, the communications device 502 includes a controller 502c connected to a receiver 502b which receives signals from an antenna 502d and a transmitter 502a also connected to the antenna 502d.

The controllers 504c, 506c are configured to control the source and target infrastructure equipment 504, 506 respectively and may comprise processor circuitry which may in turn comprise various sub-units/sub-circuits for providing functionality as explained further herein. These sub-units may be implemented as discrete hardware elements or as appropriately configured functions of the processor circuitry. Thus the controllers 504c, 506c may comprise circuitry which is suitably configured/programmed to provide the desired functionality using conventional programming/configuration techniques for equipment in wireless telecommunications systems. The transmitters 504a, 506a and the receivers 504b, 506b may comprise signal processing and radio frequency filters, amplifiers and circuitry in accordance with conventional arrangements. The transmitters 504a, 506a the receivers 504b, 506b and the controllers 504c, 506c are schematically shown in FIG. 3 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the infrastructure equipment 504 will in general comprise various other elements associated with its operating functionality.

Correspondingly, the controller 502c of the communications device 502 is configured to control the transmitter 502a and the receiver 502b and may comprise processor circuitry which may in turn comprise various sub-units/sub-circuits for providing functionality as explained further herein. These sub-units may be implemented as discrete hardware elements or as appropriately configured functions of the processor circuitry. Thus the controller 502c may comprise circuitry which is suitably configured/programmed to provide the desired functionality using conventional programming/configuration techniques for equipment in wireless telecommunications systems. Likewise, the transmitter 502a and the receiver 502b may comprise signal processing and radio frequency filters, amplifiers and circuitry in accordance with conventional arrangements. The transmitters 502a, receivers 502b, and controllers 502c are schematically shown in FIG. 3 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the communications device 502 will in general comprise various other elements associated with its operating functionality, for example a power source, user interface, and so forth, but these are not shown in FIG. 3 in the interests of simplicity.

The controllers 504c, 502c may be configured to carry out instructions which are stored on a computer readable medium, such as a non-volatile memory. The processing steps described herein may be carried out by, for example, a microprocessor in conjunction with a random access memory, operating according to instructions stored on a computer readable medium.

### Conventional Conditional Handover

Aspects of NR are concerned with mobility enhancements and in particular with increasing mobility robustness for new services which require low latency and high reliability performance (such as URLLC). Situations may arise where a cell currently serving a UE may no longer be suitable or a radio link between the UE and a source gNB providing coverage in the cell is degraded. In such situations, it is generally desirable for the UE to switch to being served by a cell of a target gNB. One way of configuring a handover of a UE from a source gNB to a target gNB is referred to as a “conditional handover”.

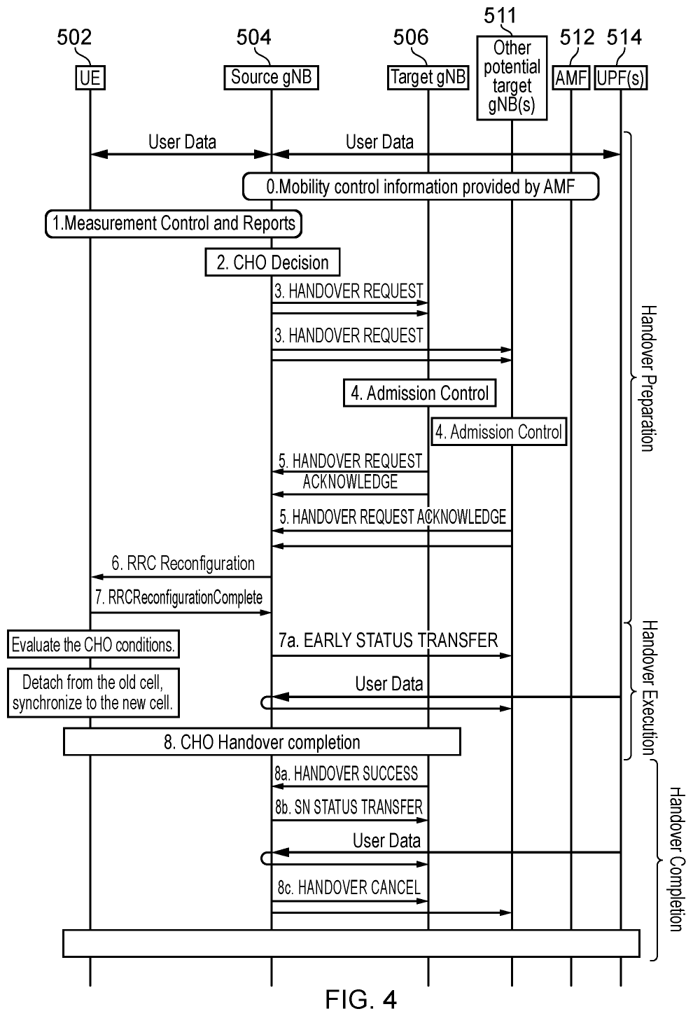

An example of a conditional handover is illustrated in FIG. 4 which is reproduced TS38.300 V16.5.0, the contents of which are incorporated by reference in their entirety. FIG. 4 schematically represents communications in a wireless communications network between the communications device 502, the source infrastructure equipment 504, the target infrastructure equipment 506, other potential target infrastructure equipment 511, an Access Mobility and Mobility Management Function (AMF) 512 and a User Plane Function (UPF) 514. In FIG. 4, the source infrastructure equipment 504, the target infrastructure equipment 506, other potential target infrastructure equipment 511 are depicted as “gNBs”, although it will be appreciated that other infrastructure equipment of a wireless communications network could be used (such as eNBs for example). The AMF 512 and UPF 514 are functions in a core network of the wireless communications network (such as core network 508).

As shown in FIG. 4, before a handover, the communications device 502 communicates user plane data with the AMF 512 and UPF 514 via the source infrastructure equipment 504. In step 0, the AMF 512 provides mobility control information to the source infrastructure equipment 504. In step 1, the communications device 502 reports measurements to the source infrastructure equipment 504. Such measurements may include measurements performed by the communications device 502 such as a Reference Signal Received Power (RSRP), Reference Signal Received Quality (RSRQ) and/or a Signal-to-Interference Ratio (SINR) of reference signals from the source infrastructure equipment 504, the target infrastructure equipment 506 and/or the other potential target infrastructure equipment 511. In step 2, the source infrastructure equipment 504 determines to configure the communications device 502 for a conditional handover. In step 3, the source infrastructure equipment 504 transmits a handover request to the target infrastructure equipment 506 and the other potential target infrastructure equipment 511. In response, in step 4, the target infrastructure equipment 506 and the other potential target infrastructure equipment 511 perform admission control. Then, in step 5, the target infrastructure equipment 506 and the other potential target infrastructure equipment 511 transmit a handover request acknowledgement to the source infrastructure equipment 504. In response to receiving the handover requests acknowledgements, the source infrastructure equipment 504 transmits, in step 6, a conditional handover configuration message to the communications device 502. The conditional handover configuration message may be a Radio Resource Control (RRC) configuration message. The conditional handover configuration message includes one or more conditions for triggering a handover of the communications device 502 from the source infrastructure equipment 504. For example, the one or more conditions in the conditional handover configuration message may include one or more conditions to be met for triggering a handover to the target infrastructure equipment 506 and one or more other conditions to be met for triggering a handover to the other potential target infrastructure equipment 511. The conditions included in the conditional handover configuration message are explained in more detail below. After receiving the conditional handover configuration message, the communications device 502 transmits an RRC reconfiguration complete message to the source infrastructure equipment 504. After receiving the conditional handover configuration message, the communications device 502 may continuously or periodically evaluate the conditions included in the handover configuration message for triggering the handover to determine whether the conditions for triggering the handover have been met. When the communications device 502 determines that conditions for triggering the handover have been met, the communications device 502 triggers the handover, detaches from a cell provided by the source infrastructure equipment 504 and attaches to a cell provided by the target infrastructure equipment 506. In the example shown in FIG. 4, the communications device 502 determines that the conditions for triggering a handover to the target infrastructure equipment 506 are met. While the communications device 502 is evaluating the conditions, the source infrastructure equipment 604 transmits an early status transfer to the other potential target infrastructure equipment in step 7a, and subsequent user data from the UPF 514 is routed to the other potential target infrastructure equipment 511 via the source infrastructure equipment 504. In step 8, the target infrastructure equipment 506 determines that the handover of the communications device 502 from the source infrastructure equipment 504 to the target infrastructure equipment 506 has been successful. In response, the target infrastructure equipment transmits a handover success message to the source infrastructure equipment 504 in step 8a. In step 8b, the source infrastructure equipment 504 transmits an SN status transfer message to the target infrastructure equipment 506. Subsequent user data from the UPF 514 to the source infrastructure equipment is routed to the target infrastructure equipment 506. In step 8c, a handover cancel message is transmitted from the source infrastructure equipment 504 to the target infrastructure equipment and the other potential target infrastructure equipment 511.

As mentioned above in step 6 of FIG. 4, the source infrastructure equipment 504 may transmit a conditional handover configuration message to the communications device 502 including one or more conditions for triggering the handover.

An example of a condition to be met for triggering a handover of the communications device 502 is “event A3”. The condition defined by event A3 is met if a signal quality of a cell provided by a neighbouring infrastructure equipment (for example, the target infrastructure equipment 506 or the other potential target infrastructure equipment 511) becomes a pre-defined offset higher than the signal quality of a cell provided by the source infrastructure equipment 504.

Another example of a condition to be met for triggering a handover of the communications device 502 is “event A4”. The condition defined by event A4 is met if the signal quality of the cell provided by the neighbouring infrastructure equipment is greater than an absolute threshold.

Another example of a condition to be met for triggering a handover of the communications device 502 is “event A5”. The condition defined by event A5 is met if the signal quality of the cell provided by the source infrastructure equipment 504 is less than an absolute threshold and the signal quality of the neighbouring infrastructure equipment is greater than an absolute threshold.

The “signal quality” mentioned above in respect of the definitions of events A3, A4 and A5 may be measured by the communications device 502 using one or more signal quality parameters such as RSRP, RSRQ and SINR. For example, the communications device 502 may determine that condition outlined in event A3 may be met if a measured RSRP of the cell provided by the neighbouring infrastructure equipment becomes a pre-defined offset higher than the measured RSRP for the cell provided by the source infrastructure equipment 504. In another example, may determine that condition outlined in event A3 is met if a measured RSRP and RSRQ of the cell provided by the neighbouring infrastructure equipment each respectively become a pre-defined offset higher than the measured RSRP and RSRQ for the cell provided by the source infrastructure equipment 504. In Release-16 of standards of the 3GPP group, only one reference signal type and measurements of at most two signal quality parameters are supported in determining whether event A3, A4 and/or A5 are met.

Each of events A3, A4 and A5 therefore each represent a condition for triggering a handover of the communications device 502 from the source infrastructure equipment 504. In order to trigger the handover, it may be sufficient that only one condition included in the conditional handover configuration message is met, or the triggering of the handover may require more than one or all of the conditions in the conditional handover configuration message to be met. In one example, only event A3 is included as a condition and the handover is triggered if event A3 is met. In another example, both events A3 and A4 are included as conditions and the handover is triggered if either event A3 or A4 is met. In another example, both events A3 and A4 are included as conditions and the handover is triggered if both events A3 or A4 are met.

Further details of events A3, A4 and A5 are provided in TS 36.331 which is hereby incorporated by reference in its entirety.

### Sidelink Relay

As mentioned above, the introduction of a wide range of new device types and capabilities in NR creates technical challenges in maintaining device connectivity with a wireless communications network. One aspect of NR currently under development of the 3GPP group is sidelink relay which is discussed in Release-17 of standards of the 3GPP group. For example, the study item (SID) for RP-193253 discusses targeting a single-hop NR sidelink-based relay. In particular, SID RP-193253 targets:
1. Study mechanism(s) with minimum specification impact to support Service and System Aspect (SA) requirements for sidelink-based UE-to-network and UE-to-UE relay, focusing on the following aspects (if applicable) for layer-3 relay and layer-2 relay [RAN2];
   Relay (re-)selection criterion and procedure;
   Relay/Remote UE authorization;
   QoS for relaying functionality;
   Service continuity;
   Security of relayed connection after SA3 has provided its conclusions;
   Impact on user plane protocol stack and control plane procedure, e.g., connection management of relayed connection.
2. Study mechanism(s) to support upper layer operations of discovery model/procedure for sidelink relaying, assuming no new physical layer channel/signal [RAN2];

The study takes account of further input from SA Working Groups (WGs), e.g., SA2 and SA3, for the bullets above (if applicable). It is expected that UE-to-network relay and UE-to-UE relay will use relaying solution. Forward compatibility for multi-hop relay support in a future releases of standards should be taken into account. For layer-2 UE-to-network relay, the architecture of end-to-end Packet Data Convergence Protocol (PDCP) and hop-by-hop Radio Link Control (RLC), as recommended in TR 36.746, is taken as starting point.

In Release-17 of the 3GPP standards, a handover of a remote UE from one relay UE to another relay UE is not supported. However, it is expected that future wireless communications networks will support UEs which are configured to handover (from either a source infrastructure equipment or source relay communications device) to a target infrastructure equipment (such as a gNB) or a target relay UE. In such scenarios, the UE may be confronted with a choice of a target infrastructure equipment or a target relay UE as candidate targets for the handover. In view of this, there is a need for improved handover procedures in wireless communications networks.

In view of the above, there is provided a method of operating a communications device to transmit and/or to receive signals from a wireless communications network. The method comprises receiving, by the communications device from the wireless communications network, one or more conditions for triggering a handover of the communications device to a target infrastructure equipment of the wireless communications network and one or more conditions for triggering a handover of the communications device to a target communications device configured to relay signals between the communications device and the wireless communications network. In some embodiments, the one or more conditions for triggering the handover to the target infrastructure equipment and the one or more conditions for triggering the handover to the target relay communications device are received in the same message. The target infrastructure equipment and target relay communications device are candidate targets for the handover. In some embodiments, the communications device determines that the target infrastructure equipment and the target relay communications device are candidate targets for the handover based on the received one or more conditions.

A source infrastructure equipment of the wireless communication network may configure the conditions for the communications device. The communications device may receive the conditions directly from the source infrastructure equipment of the wireless communications network or from the source infrastructure equipment via a source relay communications device. The target infrastructure equipment and the target relay communications device are candidate targets for a handover of the communications device.

As will be explained in more detail below, the one or more conditions for triggering the handover to the target infrastructure equipment or the target relay communications device may include one or more execution conditions triggering an initiation of the handover to the target infrastructure equipment or target relay communications device (execution conditions) and one or more conditions for triggering an evaluation of the conditions for triggering an initiation of the handover to the target infrastructure equipment or the target relay communications device (evaluation conditions).

In some embodiments, the conditions are received by the communications device from a source infrastructure equipment over a wireless access interface provided by the source infrastructure equipment for communications with the communications device (such as a Uu interface). In such embodiments, the source infrastructure may be the source of the handover. In other embodiments, the conditions are received by the communications device from the source infrastructure equipment over a wireless access interface provided by a source relay communications device (such as a PC-5 interface). In such embodiments, the source relay communications device may be the source of the handover.

The method comprises evaluating the one or more conditions for triggering the handover to the target infrastructure equipment and the one or more conditions for triggering the handover to the target relay communications device. For example, the communications device may continuously or periodically monitor the conditions to determine if any of the conditions have been met.

The method comprises initiating the handover to the target infrastructure equipment or the target relay communications device based on the evaluation of the one or more conditions for triggering the handover to the target infrastructure equipment and the one or more conditions for triggering the handover to the target relay communications device. In some embodiments, the communications device may determine that one or more of the conditions for triggering the handover to the target infrastructure equipment have been met and, in response, the communications device initiates the handover to the target infrastructure equipment. In some embodiments, the communications device may determine that one or more of the conditions for triggering the handover to the target relay communications device have been met and, in response, the communications device initiates the handover to the target relay communications device. For example, the communications device may determine to initiate the handover to the target relay communications device because one or more of the conditions for triggering the handover to the target relay communications device is met before one or more of the conditions for triggering the handover to the target infrastructure equipment is met. In some embodiments, the communications device may determine that one or more of the conditions for triggering the handover to the target infrastructure equipment and one or more of the conditions for triggering the handover to the target relay communications device are met. In such cases, the communications device may be pre-configured by the wireless communications network to select to handover to either the target infrastructure equipment or the target relay communications device. In some embodiments, the wireless communications network may transmit one or more “conflict conditions” to the communications device. The conflict conditions may be conditions used by the communications device to determine whether to handover to the target infrastructure equipment or the target relay communications device when conditions for triggering the handover to the target infrastructure equipment and target relay communications device are both met. The conflict conditions may be based on a measured signal quality and/or a speed of the communications device for example. In some embodiments, the one or more conditions for triggering the handover to the target infrastructure equipment and the one or more of the conditions for triggering the handover to the target relay communications device are configured by the source infrastructure equipment such that it is not possible for both conditions to be simultaneously met. For example, a condition for handing over to the target infrastructure equipment may be that a measured speed of the communications device is above a threshold whereas a condition for handing over to the target relay communications device may be that the measured speed of the communications device is below the same threshold. Such embodiments avoid the use of conflict conditions. In other embodiments, the one or more conditions for triggering the handover to the target infrastructure equipment and the one or more of the conditions for triggering the handover to the target relay communications device are configured by the source infrastructure equipment such that it is possible for both conditions to be simultaneously met. For example, a condition for handing over to the target infrastructure equipment may be that a measured speed of the communications device is above a threshold whereas a condition for handing over to the target relay communications device may be that the measured speed of the communications device is below a different threshold. In such embodiments, conflict conditions may be transmitted to the communications device to enable it to choose between the target infrastructure equipment or the target relay communications device as a target for the handover as explained above.

The initiation of the handover may involve detaching from a wireless access interface or radio link provided by the source infrastructure equipment or source relay communications device and attaching to a wireless access interface or radio link provided by the target infrastructure equipment or the target relay communications device. The initiation of the handover may include establishing a wireless connection with the target relay communications device or the target relay infrastructure equipment. For example, the communications device may initiate an access procedure with either the target infrastructure equipment or the target relay communications device. In one example, the communications device may initiate a Random Access Channel (RACH) procedure with the target infrastructure equipment. In another example, the communications device may initiate a PC5-RRC connection establishment with the target relay communications device.

Embodiments can therefore assist a communications device in making an informed selection between a target infrastructure equipment and a target relay communications device as candidate targets for the handover. The one or more conditions for triggering a handover of the communications device to a target infrastructure equipment of the wireless communications network and the one or more conditions for triggering a handover of the communications device to the target relay communications device may reflect preferences of the wireless communications network itself or of the communications device to be handed over.

For example, a communications device may prefer to handover to a target infrastructure equipment rather than a target relay communications device for any of the following example reasons:
The communications device is a fast moving communications device,
A serving cell of the target relay communications device is different than a serving cell of the communications device, or
The communications device is a moving communications device.
The communications device prefers the direct link to the infrastructure equipment rather than the target relay communications device if both have similar signal quality.

On the other hand, a communications device may prefer to handover to the target relay communications device rather than the target infrastructure equipment for any of the following example reasons:
The communications device and the target relay communications device are in a group, or
The communications device and the target relay communications device move together

As will be explained in more detail below, the one or more conditions for triggering the handover to the target infrastructure equipment and the one or more conditions for triggering the handover to the target relay communications device may be based on the above preferences and a radio link quality/signal quality of a prospective PC-5 link between the communications device and the target relay communications device, and a prospective Uu link between the communications device and the target infrastructure equipment. Accordingly, even in a case where a signal quality of reference signals received from the target infrastructure equipment and the target relay communications device are similar, the communications device may make an informed selection of the target of the handover.

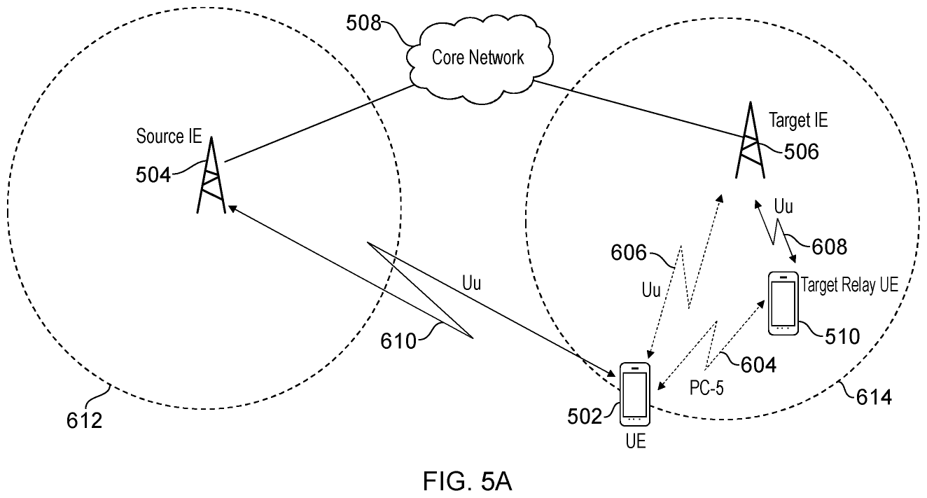

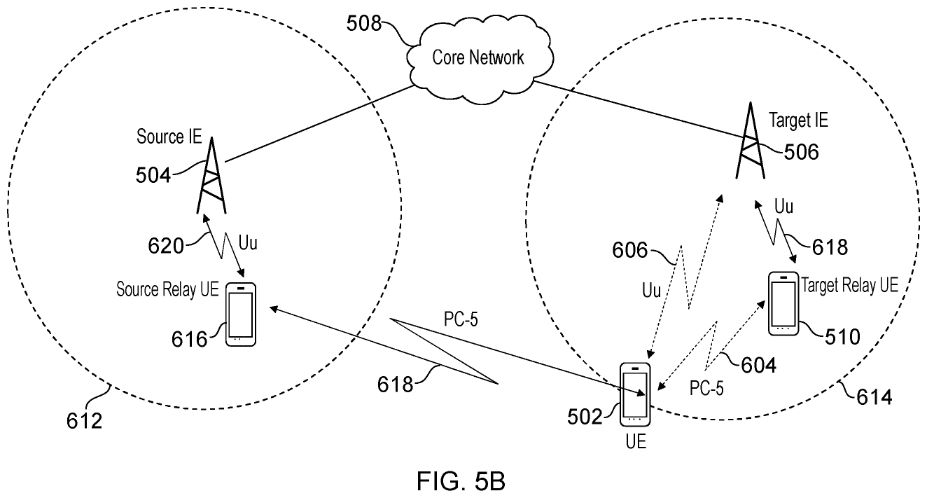

FIG. 5A is a schematic diagram illustrating a handover of a communications device from a source infrastructure equipment to a target infrastructure equipment or to a target relay communications device according to example embodiments. FIG. 5A schematically represents a source infrastructure equipment 504 providing a source cell or coverage area 612 and a target infrastructure equipment 506 providing a target cell or coverage area 614 with the source 504 and target 506 infrastructure equipment being physically connected to the core network 508. At the instant depicted in FIG. 5A, the communications device 502 is communicating with the source infrastructure equipment 504 over a Uu wireless access interface 610. Consequently, FIG. 5A depicts an instant in time before the handover. In the example shown in FIG. 5A, the target relay communications device 510 and the target infrastructure equipment 506 are candidate targets of the handover. The target relay communications device 510 is configured to act as a relay for the communications device 502 to the target infrastructure equipment 506. In particular, if the communications device 502 hands over to the target relay communications device 510, then the target relay communications device 510 will be configured to relay signals received from the communications device 502 over a PC-5 wireless access interface 604 to the target infrastructure equipment 506 via a Uu wireless access interface 608. The PC-5 wireless access interface 604 may alternatively be referred to as a sidelink interface. On the other hand, if the communications device 502 hands over to the target infrastructure equipment 506, then the target infrastructure equipment 506 will be configured to communicate signals with the communications device 502 over a Uu wireless access interface 606.

In other example embodiments (not shown), the target relay communications device 510 may be configured to act as a relay to the source infrastructure equipment 504 or another infrastructure equipment in the wireless communications network. In some embodiments, the communications device 502 may have a plurality of candidate target infrastructure equipment and a plurality of candidate target relay communications devices from which to choose.

FIG. 5B is based on FIG. 5A but schematically illustrates a handover of a communications device from a source relay communications device to a target infrastructure equipment or to a target relay communications device according to example embodiments. In particular, FIG. 5B illustrates a source relay communications device 616 which is configured to relay signals from the source infrastructure equipment 504 to the communications device 502 and relay signals from the communications device 502 to the source infrastructure equipment 504 before the handover. The source infrastructure equipment provides a Uu wireless access interface 620 for communicating signals with the source relay communications device 616, and the source relay communications device 616 provides a PC-5 wireless access interface for communicating signals with the communications device 502. The source relay communications device 616 and the target relay communications device 510 may have a similar configuration to the communications device 502 as explained with reference to FIG. 3.

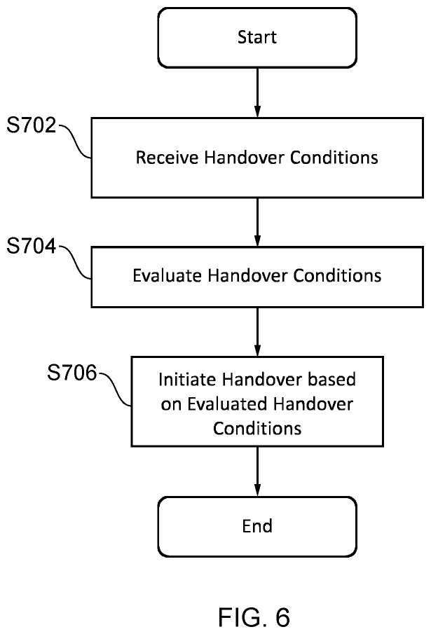

Both FIGS. 5A and 5B illustrate scenarios in which the candidate targets for the handover include a target infrastructure equipment and a target relay communications device. FIG. 6 is a flow diagram illustrating steps performed by the communications device 502 in view of such a situation according to example embodiments.

In step S702, the communications device 502 receives, from the wireless communications network, one or more conditions for triggering a handover to the target infrastructure equipment 506 and one or more conditions for triggering a handover to the target relay communications device 502. In the example scenario shown in FIG. 5A, the communications device 502 may receive the conditions from the source infrastructure equipment 504 over the Uu wireless access interface 610. In the example scenario shown in FIG. 5B, the communications device 502 may receive the conditions from the source infrastructure equipment 504 via the source relay communications device 616. For example, the source infrastructure equipment 504 may transmit the conditions to the source relay communications device 616 over the Uu wireless access interface 620 and the source relay communications device 616 may transmit the conditions to the communications device 502 over the PC-5 wireless access interface 618.

In step S704, the communications device 502 evaluates the received conditions. For example, the communications device 502 may continuously or periodically monitor the conditions to determine whether any of the conditions have been met.

In step S706, the communications device 502 initiates the handover to the target infrastructure equipment or the target relay communications device based on the evaluation of the one or more conditions for triggering the handover to the target infrastructure equipment and the one or more conditions for triggering the handover to the target relay communications device. For example, the communications device 502 may determine that one or more of the conditions for triggering the handover to the target infrastructure equipment 506 have been met and, in response, initiates the handover to the target infrastructure equipment 506. Alternatively, the communications device 502 may determine that one or more of the conditions for triggering the handover to the target relay communications device 510 have been met and, in response, initiates the handover to the target relay communications device 510.

### Conditions for Triggering a Handover

In some embodiments, the one or more conditions for triggering the handover to the target infrastructure equipment 506 may be based on a signal quality of reference signals received from the target infrastructure equipment 506 and an absolute speed of the communications device 502. The absolute speed of the communications device is the speed of the communications device 502 relative to the source infrastructure equipment which may be stationary. For example, the communications device 502 may measure an RSRP of one or more reference signals received from the target infrastructure equipment 506 and measure an absolute speed of the communications device 502. The communications device 502 may measure its absolute speed based on one or more reference signals received from the wireless communications network. For example, the communications device 502 may receive a positioning reference signal (PRS) from each of a plurality of infrastructure equipment (which may include the source infrastructure equipment 504 and/or target infrastructure equipment 506). Based on the received PRS signals, the communications device 502 may determine its location. For example, the communications device 502 may determine its position based on a difference in a time of arrival of the PRS signals from the plurality of infrastructure equipment. At a later point in time, the communications device 502 may determine its location again based on a plurality of other PRS signals received from the plurality of infrastructure equipment at the later time. The communications device 502 may then calculate a distance between the two determined locations, and a time elapsed between the communications device 502 moving between the two determined locations, in order to determine its absolute speed.

In some embodiments, the communications device 502 may use Equation 1 below to calculate its absolute speed

$${v}_{abs} = \frac{{cf}_{d}}{{f}_{c}} \qquad Equation 1.$$

where v_{abs} (ms⁻¹) is the absolute speed of the communications device, f_{d} (Hz) is a Doppler Shift of the communications device 502 relative to the source infrastructure equipment 504 determined from the one or more reference signals received from the source infrastructure equipment 504, f_{c} (Hz) is the carrier frequency of the one or more reference signals from which the Doppler Shift is measured, and c is the speed of light in a vacuum (3×10⁸ ms⁻¹).

One of the conditions for triggering the handover to the target infrastructure equipment 506 may be: if the measured RSRP of the one or more reference signals received from the target infrastructure equipment 506 is greater than a threshold and the measured absolute speed of the communications device 502 is greater than a threshold then the communications device 502 determines to initiate the handover with the target infrastructure equipment 506.

Similarly, the one or more conditions for triggering the handover to the target relay communications device 510 may be based on a signal quality of reference signals received from the target relay communications device 510 and the measured absolute speed of the communications device 502 as explained above. One of the conditions for triggering the handover to the target relay communications device 510 may be: if the measured RSRP of one or more reference signals received from the target relay communications device 510 is greater than a threshold and the measured absolute speed of the communications device 502 is less than a threshold then the communications device 502 determines to initiate the handover with the target relay communications device 510.

In some embodiments, the one or more conditions for triggering the handover to the target infrastructure equipment 506 may be based on a signal quality of reference signals received from the target infrastructure equipment 506 and a speed of the communications device 502 relative to the target infrastructure equipment 506. For example, the communications device 502 may measure an RSRP of one or more reference signals received from the target infrastructure equipment 506 and measure a speed of the communications device 502 relative to the target infrastructure equipment 506. The communications device 502 may measure its speed relative to the target infrastructure equipment 506 based on one or more reference signals received from the wireless communications network (such as PRS signals as explained above). If the target infrastructure equipment 506 is stationary, the speed of the communications device 502 relative to the target infrastructure equipment 506 may be calculated by the communications device 502 based one or more reference signals received from the target infrastructure equipment 506 as described above for the source infrastructure equipment 504. In some embodiments, where the target infrastructure equipment 506 is stationary, the speed of the communications device 502 relative to the target infrastructure equipment 506 may be calculated using Equation 1 above where the Doppler Shift (f_{d}) is a Doppler Shift of the communications device 502 relative to the target infrastructure equipment 506 determined from one or more reference signals received from the target infrastructure equipment 506 and the carrier frequency (f_{c}) is a carrier frequency of the one or more reference signals from which the Doppler Shift is determined.

In some embodiments, the target infrastructure equipment 506 may be mobile. For example, the target infrastructure equipment 506 may be a drone base station. In such embodiments, the communications device 502 may calculate its speed relative to the target infrastructure equipment 506 based on a measured Received Signal Code Power (RSCP) of one or more reference signals received from the target infrastructure equipment 506. For example, the communications device 502 may measure an RSCP of a reference signal received from the target infrastructure equipment 506 at a first time and a second, later time respectively and calculate the relative speed according to Equation 2 below

$${v}_{rel} = \frac{RSCP ( {t}_{2} ) - RSCP ( {t}_{1} )}{{t}_{2} - {t}_{1}} \qquad Equation 2.$$

where vᵣₑₗ is the speed of the communications device 502 relative to the target infrastructure equipment 506, RSCP (t₁) is a measurement of RSCP of a reference signal received from the target infrastructure equipment 506 at time t₁ and RSCP (t₂) is a measurement of RSCP of a reference signal received from the target infrastructure equipment 506 at time t₂ later than t₁. In some embodiments, where the measurements of RSCP fluctuate, smoothing or averaging of measured RSCP values is desirable.

In some embodiments, when the target infrastructure equipment 506 is mobile, the communications device 502 may calculate its speed relative to the target infrastructure equipment 506 based on one or more periodically received signals from the target infrastructure equipment 506 such as synchronisation signals. It will be appreciated that if the time between reception of the synchronisation signals increases then the communications device 502 is moving away from the target infrastructure equipment 506. Conversely, if the time between reception of the synchronisation signals decreases then the communications device 502 is moving towards the target infrastructure equipment 506.

In some embodiments, when the target infrastructure equipment 506 is mobile, the communications device 502 calculates the relative speed between the communications device 502 and the target infrastructure equipment 506 based on a Doppler Shift relative to the target infrastructure equipment 506 determined from one or more reference signals received from the target infrastructure equipment. For example, the communications device may calculate the relative speed using Equation 1 above.

In some embodiments, when the target infrastructure equipment 506 is mobile, the communications device 502 calculates the relative speed between the communications device 502 and the target infrastructure equipment 506 based on one or more PRS signals received from the wireless communications network as explained above. In some cases, the target infrastructure equipment 506 may be required to share its PRS configuration with the communications device 502 and this may be included in a conditional handover configuration message.

One of the conditions for triggering the handover to the target infrastructure equipment 506 may be: if the measured RSRP the one or more reference signals received from the target infrastructure equipment 506 is greater than a threshold and the measured speed of the communications device 502 relative to the target infrastructure equipment 506 is greater than a threshold then the communications device 502 determines to initiate the handover with the target infrastructure equipment 506.

Similarly, the one or more conditions for triggering the handover to the target relay communications device 510 may be based on a signal quality of reference signals received from the target relay communications device 510 and a speed of the communications device 502 relative to the target relay communications device 510. For example, the communications device 502 may measure an RSRP of one or more reference signals received from the target relay communications device 510 and measure a speed of the communications device 502 relative to the target relay communications device 510 as explained above. If the target relay communications device 510 is stationary, the speed of the communications device 502 relative to the target relay communications device 510 may be calculated by the communications device 502 based one or more reference signals received from the target relay communications device 510 as described above for the source infrastructure equipment 504. Alternatively, the speed of the communications device 502 relative to the target relay communications device 510 may be calculated using Equation 1 above where the Doppler Shift (f_{d}) is a Doppler Shift of the communications device 502 relative to the target relay communications device 510 determined from one or more reference signals received from the target relay communications device 510 and the carrier frequency (f_{c}) is a carrier frequency of the one or more reference signals from which the Doppler Shift is determined.

In some embodiments, where the target relay communications device 510 is mobile, the communications device 502 may calculate its speed relative to the target relay communications device 510 based on a measured RSCP of one or more reference signals received from the target relay communications device 510. For example, the communications device 502 may determine its speed relative to the target relay communications device 510 according to Equation 2 above where RSCP (t₁) and RSCP (t₂) are measurements of RSCP of respective reference signals received at a time t₁ and a later time t₂ from the target relay communications device 510.

In some embodiments, when the target relay communications device 510 is mobile, the communications device 502 may calculate its speed relative to the target relay communications device 510 based on one or more periodically received signals from the target relay communications device 510 such as synchronisation signals. It will be appreciated that if the time between reception of the synchronisation signals increases then the communications device 502 is moving away from the target relay communications device 510. Conversely, if the time between reception of the synchronisation signals decreases then the communications device 502 is moving towards the target relay communications device 510.

In some embodiments, when the target relay communications device 510 is mobile, the communications device 502 calculates the relative speed between the communications device 502 and the target relay communications device 510 based on a Doppler Shift relative to the target relay communications device 510 determined from one or more reference signals received from the target infrastructure equipment. For example, the communications device 502 may calculate the relative speed according to Equation 1 above.

In some embodiments, when the target relay communications device 510 is mobile, the communications device 502 calculates the relative speed between the communications device 502 and the target relay communications device 510 based on one or more PRS signals. In some cases, the communications device 502 may use PRS signals received from the target relay communications device 510, as well as the PRS signals from a plurality of infrastructure equipment, in order to determine the relative speed between the communications device 502 and the target relay communications device 510. In some cases, the target relay communications device 510 may be required to share its PRS configuration with the communications device 502 and this may be included in a conditional handover configuration message.

One of the conditions for triggering the handover to the target relay communications device 510 may be: if the measured RSRP of the one or more reference signals received from the target relay communications device 510 is greater than a threshold and the measured speed of the communications device 502 relative to the target relay communications device 510 is less than a threshold then the communications device 502 determines to initiate the handover with the target relay communications device 510.

The above described embodiments can increase communications resource utilisation efficiency in the wireless communications network. For example, if the communications device 502 is a fast moving communications device, then it is preferable to select an infrastructure equipment as a target for the handover to minimise a number of link switches. However, if the communications device 502 is moving together with the target relay communications device 510, then switching to the target relay communications device is preferable.

In some example embodiments, the one or more conditions for triggering the handover to the target infrastructure equipment 506 or the target relay communications device 510 may be configured to reduce signalling overhead in the wireless communications network. For example, in some embodiments, one of the conditions for triggering the handover to the target infrastructure equipment 510 may be based on a measured signal quality of reference signals received from the target infrastructure equipment and whether or not the target candidate relay communications device 510 is in a different cell compared with the communications device 502. An indication of an identity of the cell to which the target candidate relay communications device 510 belongs may be received by the communications device 502 from the target relay communications device 510. One condition for triggering the handover to the target infrastructure equipment 510 may be that the measured RSRP of one or more reference signals received from the target relay infrastructure equipment 510 is greater than a threshold and that the target relay communications device 510 is in a different cell compared with the communications device 502.

Similarly, one of the conditions for triggering the handover to the target relay communications device 510 may be based on a measured signal quality of reference signals received from the target relay communications device 510 and an indication of whether or not the target candidate relay communications device 510 is in a different cell compared with the communications device 502 as explained above. One condition for triggering the handover to the target infrastructure equipment 510 may be that the measured RSRP of one or more reference signals received from the target relay communications device 510 is greater than a threshold and that the target relay communications device 510 is in the same cell compared with the communications device 502.

As will be appreciated, supporting multiple communications devices in a wireless communications network which belong to different Public Land Mobile networks (PLMN) or cells may incur signalling overhead. Accordingly, the conditions received from the wireless communications network can be configured to reduce signalling overhead in the wireless communications network.

In some embodiments, the one or more conditions for triggering the handover to the target infrastructure equipment 506 or the target relay communications device 510 may be based on a comparison of a signal quality of reference signals received from the target infrastructure equipment 506 and the target relay communications device 510. For example, one condition for triggering the handover to the target infrastructure equipment 506 may be that the RSRP of one or more reference signals received from the target infrastructure equipment 506 is greater than a combined value of the RSRP of one or more reference signals received from the target relay communications device 510 and an offset. An example of a condition for triggering the handover to the target relay communications device 510 may be that the combined value of the RSRP of one or more reference signals received from the target relay communications device 510 and an offset is greater than the RSRP one or more reference signals received from the target infrastructure equipment 506. In some embodiments, the offset may be included in the conditions to bias the communications device 502 towards the selection of the target infrastructure equipment 506 or the target relay communications device 510. In other embodiments, the offset may be selected by the wireless communications network to adjust a radio link quality difference between PC-5 604 and Uu 606. In other embodiments, the offset may be selected by the wireless communications network to reflect a hysteresis between PC-5 604 and Uu 606. In other embodiments, the offset is zero.

In some embodiments, the one or more conditions for triggering a handover to the target infrastructure equipment 506 and the one or more conditions for triggering a handover to the target relay communications device 510 may be included in a conditional handover configuration message (such as the conditional handover configuration message transmitted in step 6 of FIG. 4).

### Execution, Evaluation and Conditional Handover Configuration Conditions

An execution condition for the target infrastructure equipment 506 or target relay communications device 510 may be any of the previously mentioned “one or more conditions for triggering a handover” to the target infrastructure equipment 506 or target relay communications device 510. An execution condition may be referred to as a condition for triggering an initiation of the handover the target infrastructure equipment 506 or the target relay communications device 510. In some embodiments, the “one or more conditions for triggering a handover” to the target infrastructure equipment 506 or target relay communications device 510 only contain execution conditions.

In other embodiments, the “one or more conditions for triggering a handover” may include execution conditions and evaluation conditions. An evaluation condition is a condition for triggering an evaluation of an execution condition and may be any of the previously mentioned “one or more conditions for triggering a handover” to the target infrastructure equipment 506 or target relay communications device 510. In other words, in some embodiments, if an evaluation condition is met, then an execution condition is evaluated and, if the execution condition is met, the handover is initiated.

In other embodiments, the “one or more conditions for triggering a handover” may include execution conditions and conditional handover (CHO) configuration conditions. A CHO configuration condition is a condition for triggering a configuration of the communications device 502 for a conditional handover and may be any of the previously mentioned “one or more conditions for triggering a handover” to the target infrastructure equipment 506 or target relay communications device 510. For example, if a CHO configuration condition is met, the source infrastructure equipment 504 may configure the communications device 502 with a configuration for the handover to the target infrastructure equipment 506 or target relay communications device 510 including the execution conditions. The communications device 502 may transmit a measurement report to the wireless communications network when a CHO configuration condition is met and, in response, the wireless communications network may configure a conditional handover based on the measurement report. Then, when an execution condition is met, the handover is initiated.

In some embodiments, the “one or more conditions for triggering a handover” may include execution conditions, evaluation conditions and CHO configuration conditions.

In some embodiments, the execution conditions for the handover to the target infrastructure equipment 506 and the target relay communications device 510 may be included in a conditional handover configuration message (such as the conditional handover configuration message transmitted in step 6 of FIG. 4) and the evaluation conditions for the handover to the target infrastructure equipment 506 and the target relay communications device 510 are transmitted to the communications device 502 from the source infrastructure equipment 504 separately to the execution conditions.

Embodiments which differentiate between execution conditions, evaluation and/or CHO configuration conditions enable the wireless communications network to configure these conditions separately. For example, evaluation conditions may be based on signal quality and the execution conditions may be based on a relative speed of the communications device 510. If the communications device 502 determines that one or more evaluation conditions is met, it will proceed to evaluate the execution conditions. For example, if the communications device 502 determines that one or more evaluation conditions for the target infrastructure equipment 506 are met, the communications device 502 may proceed to evaluate the execution conditions for the target infrastructure equipment 506. Similarly, if the communications device 502 determines that one or more evaluation conditions for the target relay communications device 510 are met, the communications device 502 may proceed to evaluate the execution conditions for the target relay communications device 510.

Further examples of evaluation and CHO configuration conditions according to example embodiments are given below.

In some embodiments, an evaluation condition or a CHO configuration condition is that a measured signal quality of reference signals received from the target infrastructure equipment 506 is below a threshold and that the measured absolute speed of the communications device 502 is above a threshold.

In some embodiments, an evaluation condition or a CHO configuration condition is that a measured signal quality of reference signals received from the target relay communications device 604 is below a threshold and that the measured absolute speed of the communications device 502 is above a threshold.

In some embodiments, an evaluation condition or a CHO configuration condition is that a measured signal quality of reference signals received from the target infrastructure equipment 506 is below a threshold and that a measured speed of the communications device 502 relative to the target infrastructure equipment 506 is above a threshold.

In some embodiments, an evaluation condition or a CHO configuration condition is that a measured signal quality of reference signals received from the target relay communications device 510 is below a threshold and that the measured speed of the communications device 502 relative to the target relay communications device 510 is above a threshold.

In some embodiments, an evaluation condition or a CHO configuration condition is that a measured signal quality of reference signals received from the target relay communications device 510 is below a threshold and that the PLMN or cell of the target relay communications device 510 is different from the PLMN or cell of the communications device 502.

In some embodiments, an evaluation condition or a CHO configuration condition is based on a comparison between a measured signal quality of reference signals received from the target infrastructure equipment 506 and the target relay communications device 510. For example, an evaluation condition or a CHO configuration condition may be that the combined value of a measured signal quality of reference signals received from the target relay communications device plus an offset is less than a measured signal quality of reference signals received from the target infrastructure equipment 506.

In some embodiments, an evaluation condition or a CHO configuration condition is that a measured signal quality of reference signals received from the source infrastructure equipment 504 is below a threshold and that the measured absolute speed of the communications device 502 is above a threshold.

In some embodiments, an evaluation condition or a CHO configuration condition is that a measured signal quality of reference signals received from the source relay communications device 616 is below a threshold and that the measured absolute speed of the communications device 502 is above threshold.

In some embodiments, an evaluation condition or a CHO configuration condition is that a measured signal quality of reference signals received from the source infrastructure equipment 504 is below a threshold and that a measured speed of the communications device 502 relative to the source infrastructure equipment 504 is above a threshold.

In some embodiments, an evaluation condition or a CHO configuration condition is that a measured signal quality of reference signals received from the source relay communications device 616 is below a threshold and that the measured speed of the communications device 502 relative to the source relay communications device 616 is above threshold.

In some embodiments, an evaluation condition or a CHO configuration condition is that a measured signal quality of reference signals received from the source relay communications device 616 is below a threshold and that the PLMN or cell of the source relay communications device 616 is different from the PLMN or cell of the communications device 502.

In some embodiments, an evaluation condition or a CHO configuration condition is based on a comparison between a measured signal quality of reference signals received from the source infrastructure equipment 504 and the source relay communications device 616. For example, an evaluation condition or a CHO configuration condition may be that the combined value of a measured signal quality of reference signals received from the source relay communications device 616 plus an offset is less than a measured signal quality of reference signals received from the source infrastructure equipment 504 (such as Uu 610).

Although various examples of conditions for triggering a handover to the target infrastructure equipment 506 and the target communications device 5510 have been discussed, it will be appreciated that any combination of conditions as described herein could be used. In some cases, the conditions for triggering the handover to the target infrastructure equipment 506 and the target communications device 502 may be reciprocal conditions. For example, if a condition for triggering a handover to the target infrastructure equipment 506 is met, then the communications device 502 hands over to the target infrastructure equipment but, if the condition is not met, then the communications device 502 hands over to the target relay communications device 510.

In some embodiments, the evaluation conditions for the target infrastructure equipment 506 and the target communications device 502 are the same conditions. For example, if a signal quality of reference signals received from the source infrastructure equipment 504 falls below a threshold, then the execution conditions for both the target infrastructure equipment 506 and the target relay communications device 510 are evaluated.

It will be appreciated that while the present disclosure has in some respects focused on implementations in an LTE-based and/or 5G network for the sake of providing specific examples, the same principles can be applied to other wireless telecommunications systems. Thus, even though the terminology used herein is generally the same or similar to that of the LTE and 5G standards, the teachings are not limited to the present versions of LTE and 5G and could apply equally to any appropriate arrangement not based on LTE or 5G and/or compliant with any other future version of an LTE, 5G or other standard.

It may be noted various example approaches discussed herein may rely on information which is predetermined/predefined in the sense of being known by both the base station and the communications device. It will be appreciated such predetermined/predefined information may in general be established, for example, by definition in an operating standard for the wireless telecommunication system, or in previously exchanged signalling between the base station and communications devices, for example in system information signalling, or in association with radio resource control setup signalling, or in information stored in a SIM application. That is to say, the specific manner in which the relevant predefined information is established and shared between the various elements of the wireless telecommunications system is not of primary significance to the principles of operation described herein. It may further be noted various example approaches discussed herein rely on information which is exchanged/communicated between various elements of the wireless telecommunications system and it will be appreciated such communications may in general be made in accordance with conventional techniques, for example in terms of specific signalling protocols and the type of communication channel used, unless the context demands otherwise. That is to say, the specific manner in which the relevant information is exchanged between the various elements of the wireless telecommunications system is not of primary significance to the principles of operation described herein.

It will be appreciated that the principles described herein are not applicable only to certain types of communications device, but can be applied more generally in respect of any types of communications device, for example the approaches are not limited to URLLC/IIoT devices or other low latency communications devices, but can be applied more generally, for example in respect of any type of communications device operating with a wireless link to the communication network.

It will further be appreciated that the principles described herein are applicable not only to LTE-based or 5G/NR-based wireless telecommunications systems, but are applicable for any type of wireless telecommunications system that supports a dynamic scheduling of shared communications resources.

Further particular and preferred aspects of the present invention are set out in the accompanying independent and dependent claims. It will be appreciated that features of the dependent claims may be combined with features of the independent claims in combinations other than those explicitly set out in the claims.

Thus, the foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, define, in part, the scope of the foregoing claim terminology such that no inventive subject matter is dedicated to the public.

Respective features of the present disclosure are defined by the following numbered paragraphs:

Paragraph 1. A method of operating a communications device to transmit and/or to receive signals from a wireless communications network, the method comprising
receiving, by the communications device from the wireless communications network, one or more conditions for triggering a handover of the communications device to a target infrastructure equipment of the wireless communications network and one or more conditions for triggering a handover of the communications device to a target communications device configured to relay signals between the communications device and the wireless communications network,
evaluating the one or more conditions for triggering the handover to the target infrastructure equipment and the one or more conditions for triggering the handover to the target relay communications device, and
initiating the handover to the target infrastructure equipment or the target relay communications device based on the evaluation of the one or more conditions for triggering the handover to the target infrastructure equipment and the one or more conditions for triggering the handover to the target relay communications device.

Paragraph 2. A method according to paragraph 1, wherein the initiating the handover to the target infrastructure equipment or the target relay communications device based on the evaluation of the one or more conditions for triggering the handover to the target infrastructure equipment and the one or more conditions for triggering the handover to the target relay communications device comprises either
determining that one or more of the conditions for triggering the handover to the target infrastructure equipment have been met and, in response, initiating the handover to the target infrastructure equipment, or
determining that one or more of the conditions for triggering the handover to the target relay communications device have been met and, in response, initiating the handover to the target relay communications device.

Paragraph 3. A method according to paragraph 1 or paragraph 2, wherein one or more of the conditions for triggering the handover to the target infrastructure equipment are based on a measured signal quality of one or more reference signals received by the communications device from the target infrastructure equipment and a measured absolute speed of the communications device, and
one or more of the conditions for triggering the handover to the target relay communications device are based on a measured signal quality of one or more reference signals received by the communications device from the target relay communications device and the measured absolute speed of the communications device.

Paragraph 4. A method according to any of paragraphs 1 to 3, one or more of the conditions for triggering the handover to the target infrastructure equipment are based on a measured signal quality of one or more reference signals received by the communications device from the target infrastructure equipment and a measured speed of the communications device relative to the target infrastructure equipment, and
one or more of the conditions for triggering the handover to the target relay communications device are based on a measured signal quality of one or more reference signals received by the communications device from the target relay communications device and a measured speed of the communications device relative to the target relay communications device.

Paragraph 5. A method according to any of paragraphs 1 to 4, wherein one or more of the conditions for triggering the handover to the target infrastructure equipment are based on a measured signal quality of one or more reference signals received by the communications device from the target infrastructure equipment and an indication of whether or not the communications device is in the same or different coverage area as the target relay communications device, and
one or more of the conditions for triggering the handover to the target relay communications device are based on a measured signal quality of one or more reference signals received by the communications device from the target relay communications device and an indication of whether or not the communications device is in the same or different coverage area as the target relay communications device.

Paragraph 6. A method according to any of paragraphs 1 to 5, wherein one or more of the conditions for triggering the handover to the target infrastructure equipment are based on a comparison of a measured signal quality of one or more reference signals received from the target infrastructure equipment and the target relay communications device and
one or more of the conditions for triggering the handover to the target relay communications device are based on a comparison of a measured signal quality of one or more reference signals received from the target infrastructure equipment and the target relay communications device.

Paragraph 7. A method according to any of paragraphs 1 to 6, wherein the evaluating the one or more conditions for triggering the handover to the target infrastructure equipment and the one or more conditions for triggering the handover to the target relay communications device comprises
identifying, from among the one or more conditions for triggering the handover to the target infrastructure equipment, one or more execution conditions for triggering the initiation of the handover to the target infrastructure equipment and one or more execution conditions for triggering the initiation of the handover to the target relay communications device, and
determining that one or more of the execution conditions for the target infrastructure equipment or the target relay communications device have been met and, in response, initiating the handover to the target infrastructure equipment or the target relay communications device.

Paragraph 8. A method according to paragraph 7, wherein the evaluating the one or more conditions for triggering the handover to the target infrastructure equipment and the one or more conditions for triggering the handover to the target relay communications device comprises
identifying, from among the one or more conditions for triggering the handover to the target relay communications device, one or more evaluation conditions for triggering an evaluation of the one or more execution conditions for the target infrastructure equipment and one or more evaluation conditions for triggering an evaluation of the one or more execution conditions for the target relay communications device,
determining that one or more of the evaluation conditions for the target infrastructure have been met and, in response, evaluating the one or more execution conditions for the target infrastructure equipment, and/or
determining that one or more of the evaluation conditions for the target relay communications device have been met and, in response, evaluating the one or more execution conditions for the target relay communications device.

Paragraph 9. A method according to paragraph 7 or paragraph 8, wherein the evaluating the one or more conditions for triggering the handover to the target infrastructure equipment and the one or more conditions for triggering the handover to the target relay communications device comprises
identifying, from among the one or more conditions for triggering the handover to the target relay communications device, one or more conditional handover, CHO, configuration conditions for triggering a configuration of a conditional handover of the communications device to the target infrastructure equipment or the target relay communications device,
determining that one or more of the CHO configuration conditions for the target infrastructure equipment have been met and, in response, transmitting, to the wireless communications network, an indication that one or more of the CHO configuration conditions for the target infrastructure equipment have been met, and/or
determining that one or more of the CHO configuration conditions for the target relay communications device have been met and, in response, transmitting, to the wireless communications network, an indication that one or more of the CHO configuration conditions for the target relay communications device have been met.

Paragraph 10. A method according to paragraph 9, wherein the indication that one or more of the CHO configuration conditions for the target infrastructure equipment or the target relay communications device have been met is a measurement report and the method comprises
receiving, from the wireless communications network in response to the transmission of the measurement report, a configuration of a conditional handover to the target infrastructure equipment or target relay communications device including the execution conditions for the target infrastructure equipment or the target relay communications device.

Paragraph 11. A method according to any of paragraphs 1 to 10, wherein, before handover, a source infrastructure equipment of the wireless communications network provides a wireless access interface for the communications device to transmit signals to and receive signals from the source infrastructure equipment, the source infrastructure being a source of the handover.

Paragraph 12. A method according to paragraph 11, wherein the one or more of the conditions for triggering the handover to the target infrastructure equipment and the one or more conditions for triggering the handover to the target relay communications device include one or more conditions based on a measured signal quality of one or more reference signals received from the source infrastructure equipment.

Paragraph 13. A method according to any of paragraphs 1 to 12, wherein, before handover, a source infrastructure equipment of the wireless communications network provides a wireless access interface for a source relay communications device to transmit signals to and receive signals from the source infrastructure equipment, wherein the source relay communications device provides a wireless access interface for the communications device to transmit signals to and receive signals from the source infrastructure equipment via the source relay communications device, the source relay communications device being a source of the handover.

Paragraph 14. A method according to paragraph 13, wherein the one or more of the conditions for triggering the handover to the target infrastructure equipment and the one or more conditions for triggering the handover to the target relay communications device include one or more conditions based on a measured signal quality of one or more reference signals received from the source relay communications device.

Paragraph 15. A method of operating a source infrastructure equipment of a wireless communications network to transmit and/or to receive signals from a communications device, the method comprising
configuring, by the source infrastructure equipment, one or more conditions for triggering a handover of the communications device to a target infrastructure equipment of the wireless communications network and one or more conditions for triggering a handover of the communications device to a target communications device configured to relay signals between the communications device and the wireless communications network,
transmitting, by the source infrastructure equipment to the communications device, the one or more conditions for triggering the handover to the target infrastructure equipment and the one or more conditions for triggering the handover to the target relay communications device.

Paragraph 16. A method according to paragraph 15, wherein the source infrastructure equipment configures one or more of the conditions for triggering the handover to the target infrastructure equipment based on a measured signal quality of one or more reference signals received by the communications device from the target infrastructure equipment and a measured absolute speed of the communications device, and the source infrastructure equipment configures one or more of the conditions for triggering the handover to the target relay communications device based on a measured signal quality of one or more reference signals received by the communications device from the target relay communications device and the measured absolute speed of the communications device.

Paragraph 17. A method according to paragraph 15 or paragraph 16, wherein the source infrastructure equipment configures one or more of the conditions for triggering the handover to the target infrastructure equipment based on a measured signal quality of one or more reference signals received by the communications device from the target infrastructure equipment and a measured speed of the communications device relative to the target infrastructure equipment, and the source infrastructure equipment configures one or more of the conditions for triggering the handover to the target relay communications device based on a measured signal quality of one or more reference signals received by the communications device from the target relay communications device and a measured speed of the communications device relative to the target relay communications device.

Paragraph 18. A method according to any of paragraphs 15 to 17, wherein the source infrastructure equipment configures one or more of the conditions for triggering the handover to the target infrastructure equipment based on a measured signal quality of one or more reference signals received by the communications device from the target infrastructure equipment and an indication of whether or not the communications device is in the same or different coverage area as the target relay communications device, and the source infrastructure equipment configures one or more of the conditions for triggering the handover to the target relay communications device based on a measured signal quality of one or more reference signals received by the communications device from the target relay communications device and an indication of whether or not the communications device is in the same or different coverage area as the target relay communications device.

Paragraph 19. A method according to any of paragraphs 15 to 18, wherein the source infrastructure equipment configures one or more of the conditions for triggering the handover to the target infrastructure equipment based on a comparison of a measured signal quality of one or more reference signals received from the target infrastructure equipment and the target relay communications device, and the source infrastructure equipment configures one or more of the conditions for triggering the handover to the target relay communications device based on a comparison of a measured signal quality of one or more reference signals received from the target infrastructure equipment and the target relay communications device.

Paragraph 20. A method according to any of paragraphs 15 to 19, wherein the configuring the one or more conditions for triggering the handover to the target infrastructure equipment and the one or more conditions for triggering the handover to the target relay communications device comprises
configuring one or more execution conditions for triggering an initiation of the handover to the target infrastructure equipment and one or more execution conditions for triggering an initiation of the handover to the target relay communications device.

Paragraph 21. A method according to paragraph 20, wherein the configuring the one or more conditions for triggering the handover to the target infrastructure equipment and the one or more conditions for triggering the handover to the target relay communications device comprises
configuring one or more evaluation conditions for triggering an evaluation of the one or more execution conditions for the target infrastructure equipment and one or more evaluation conditions for triggering an evaluation of the one or more execution conditions for the target relay communications device.

Paragraph 22. A method according to paragraph 20 or paragraph 21, wherein the configuring the one or more conditions for triggering the handover to the target infrastructure equipment and the one or more conditions for triggering the handover to the target relay communications device comprises
configuring one or more conditional handover, CHO, configuration conditions for triggering a configuration of a conditional handover of the communications device to the target infrastructure equipment or the target relay communications device, and the method comprises
receiving, from the communications device, an indication that one or more of the CHO configuration conditions for the target infrastructure equipment have been met or an indication that one or more of the CHO configuration conditions for the target relay communications device have been met, and in response,
configuring the one or more CHO configuration conditions for the target infrastructure equipment or the target relay communications device based on the received indication,
transmitting, to the communications device, a configuration for the conditional handover including the execution conditions.

Paragraph 23. A method according to paragraph 22, wherein the received indication is a measurement report and the source infrastructure equipment configures the one or more CHO configuration conditions for the target infrastructure equipment or the target relay communications device based on the received measurement report.

Paragraph 24. A method according to any of paragraphs 15 to 23, wherein, before handover, the source infrastructure equipment provides a wireless access interface for the communications device to transmit signals to and receive signals from the source infrastructure equipment, the source infrastructure being a source of the handover.

Paragraph 25. A method according to paragraph 24, wherein the source infrastructure equipment configures one or more of the conditions for triggering the handover to the target infrastructure equipment and one or more of the conditions for triggering the handover to the target relay communications device based on a measured signal quality of one or more reference signals received by the communications device from the source infrastructure equipment.

Paragraph 26. A method according to any of paragraphs 15 to 25, wherein, before handover, the source infrastructure equipment provides a wireless access interface for a source relay communications device to transmit signals to and receive signals from the source infrastructure equipment, wherein the source relay communications device provides a wireless access interface for the communications device to transmit signals to and receive signals from the source infrastructure equipment via the source relay communications device, the source relay communications device being a source of the handover.

Paragraph 27. A method according to paragraph 26, wherein the source infrastructure equipment configures one or more of the conditions for triggering the handover to the target infrastructure equipment and one or more of the conditions for triggering the handover to the target relay communications device based on a measured signal quality of one or more reference signals received by the communications device from the source relay communications device.

Paragraph 28. A communications device operable to transmit and/or to receive signals from a wireless communications network, the communications device comprising
transmitter circuitry configured to transmit signals,
receiver circuitry configured to receive signals,
controller circuitry, configured in combination with the transmitter circuitry and the receiver circuitry,
to receive, from the wireless communications network, one or more conditions for triggering a handover of the communications device to a target infrastructure equipment of the wireless communications network and one or more conditions for triggering a handover of the communications device to a target communications device configured to relay signals between the communications device and the wireless communications network,
to evaluate the one or more conditions for triggering the handover to the target infrastructure equipment and the one or more conditions for triggering the handover to the target relay communications device, and
to initiate the handover to the target infrastructure equipment or the target relay communications device based on the evaluation of the one or more conditions for triggering the handover to the target infrastructure equipment and the one or more conditions for triggering the handover to the target relay communications device.

Paragraph 29. A communications device according to paragraph 28, wherein the controller circuitry is configured in combination with the transmitter circuitry and the receiver circuitry
to determine that one or more of the conditions for triggering the handover to the target infrastructure equipment have been met and, in response, initiating the handover to the target infrastructure equipment, or
to determine that one or more of the conditions for triggering the handover to the target relay communications device have been met and, in response, initiating the handover to the target relay communications device.

Paragraph 30. A communications device according to paragraph 28 or paragraph 29, wherein one or more of the conditions for triggering the handover to the target infrastructure equipment are based on a measured signal quality of one or more reference signals received by the communications device from the target infrastructure equipment and a measured absolute speed of the communications device, and
one or more of the conditions for triggering the handover to the target relay communications device are based on a measured signal quality of one or more reference signals received by the communications device from the target relay communications device and the measured absolute speed of the communications device.

Paragraph 31. A communications device according to any of paragraphs 28 to 30, wherein one or more of the conditions for triggering the handover to the target infrastructure equipment are based on a measured signal quality of one or more reference signals received by the communications device from the target infrastructure equipment and a measured speed of the communications device relative to the target infrastructure equipment, and
one or more of the conditions for triggering the handover to the target relay communications device are based on a measured signal quality of one or more reference signals received by the communications device from the target relay communications device and a measured speed of the communications device relative to the target relay communications device.

Paragraph 32. A communications device according to any of paragraphs 28 to 31, wherein one or more of the conditions for triggering the handover to the target infrastructure equipment are based on a measured signal quality of one or more reference signals received by the communications device from the target infrastructure equipment and an indication of whether or not the communications device is in the same or different coverage area as the target relay communications device, and
one or more of the conditions for triggering the handover to the target relay communications device are based on a measured signal quality of one or more reference signals received by the communications device from the target relay communications device and an indication of whether or not the communications device is in the same or different coverage area as the target relay communications device.

Paragraph 33. A communications device according to any of paragraphs 28 to 32, wherein one or more of the conditions for triggering the handover to the target infrastructure equipment are based on a comparison of a measured signal quality of one or more reference signals received from the target infrastructure equipment and the target relay communications device and
one or more of the conditions for triggering the handover to the target relay communications device are based on a comparison of a measured signal quality of one or more reference signals received from the target infrastructure equipment and the target relay communications device.

Paragraph 34. A communications device according to any of paragraphs 28 to 33, wherein the controller circuitry is configured in combination with the transmitter circuitry and the receiver circuitry
to identify, from among the one or more conditions for triggering the handover to the target infrastructure equipment, one or more execution conditions for triggering the initiation of the handover to the target infrastructure equipment and one or more execution conditions for triggering the initiation of the handover to the target relay communications device, and
to determine that one or more of the execution conditions for the target infrastructure equipment or the target relay communications device have been met and, in response, initiating the handover to the target infrastructure equipment or the target relay communications device.

Paragraph 35. A communications device according to paragraph 34, wherein the controller circuitry is configured in combination with the transmitter circuitry and the receiver circuitry
to identify, from among the one or more conditions for triggering the handover to the target relay communications device, one or more evaluation conditions for triggering an evaluation of the one or more execution conditions for the target infrastructure equipment and one or more evaluation conditions for triggering an evaluation of the one or more execution conditions for the target relay communications device,
to determine that one or more of the evaluation conditions for the target infrastructure have been met and, in response, evaluating the one or more execution conditions for the target infrastructure equipment, and/or
to determine that one or more of the evaluation conditions for the target relay communications device have been met and, in response, evaluating the one or more execution conditions for the target relay communications device.

Paragraph 36. A communications device according to paragraph 34 or paragraph 35, wherein the controller circuitry is configured in combination with the transmitter circuitry and the receiver circuitry
to identify, from among the one or more conditions for triggering the handover to the target relay communications device, one or more conditional handover, CHO, configuration conditions for triggering a configuration of a conditional handover of the communications device to the target infrastructure equipment or the target relay communications device,
to determine that one or more of the CHO configuration conditions for the target infrastructure equipment have been met and, in response, transmitting, to the wireless communications network, an indication that one or more of the CHO configuration conditions for the target infrastructure equipment have been met, and/or
to determine that one or more of the CHO configuration conditions for the target relay communications device have been met and, in response, transmitting, to the wireless communications network, an indication that one or more of the CHO configuration conditions for the target relay communications device have been met.

Paragraph 37. A communications device according to paragraph 36, wherein the indication that one or more of the CHO configuration conditions for the target infrastructure equipment or the target relay communications device have been met is a measurement report and the controller circuitry is configured in combination with the transmitter circuitry and the receiver circuitry
to receive, from the wireless communications network in response to the transmission of the measurement report, a configuration of a conditional handover to the target infrastructure equipment or target relay communications device including the execution conditions for the target infrastructure equipment or the target relay communications device.

Paragraph 38. A communications device according to any of paragraphs 28 to 37, wherein, before handover, a source infrastructure equipment of the wireless communications network provides a wireless access interface for the communications device to transmit signals to and receive signals from the source infrastructure equipment, the source infrastructure being a source of the handover.

Paragraph 39. A communications device according to paragraph 38, wherein the one or more of the conditions for triggering the handover to the target infrastructure equipment and the one or more conditions for triggering the handover to the target relay communications device include one or more conditions based on a measured signal quality of one or more reference signals received from the source infrastructure equipment.

Paragraph 40. A communications device according to any of paragraphs 28 to 39, wherein, before handover, a source infrastructure equipment of the wireless communications network provides a wireless access interface for a source relay communications device to transmit signals to and receive signals from the source infrastructure equipment, wherein the source relay communications device provides a wireless access interface for the communications device to transmit signals to and receive signals from the source infrastructure equipment via the source relay communications device, the source relay communications device being a source of the handover.

Paragraph 41. A communications device according to paragraph 40, wherein the one or more of the conditions for triggering the handover to the target infrastructure equipment and the one or more conditions for triggering the handover to the target relay communications device include one or more conditions based on a measured signal quality of one or more reference signals received from the source relay communications device.

Paragraph 42. A source infrastructure equipment of a wireless communications network operable to transmit and/or to receive signals from a communications device, the source infrastructure equipment comprising
transmitter circuitry configured to transmit signals,
receiver circuitry configured to receive signals,
controller circuitry, configured in combination with the transmitter circuitry and the receiver circuitry,
to configure one or more conditions for triggering a handover of the communications device to a target infrastructure equipment of the wireless communications network and one or more conditions for triggering a handover of the communications device to a target communications device configured to relay signals between the communications device and the wireless communications network,
to transmit, to the communications device, the one or more conditions for triggering the handover to the target infrastructure equipment and the one or more conditions for triggering the handover to the target relay communications device.

Paragraph 43. A source infrastructure equipment according to paragraph 42, wherein the controller circuitry is configured in combination with the transmitter circuitry and the receiver circuitry
to configure one or more of the conditions for triggering the handover to the target infrastructure equipment based on a measured signal quality of one or more reference signals received by the communications device from the target infrastructure equipment and a measured absolute speed of the communications device, and
to configure one or more of the conditions for triggering the handover to the target relay communications device based on a measured signal quality of one or more reference signals received by the communications device from the target relay communications device and the measured absolute speed of the communications device.

Paragraph 44. A source infrastructure equipment according to paragraph 42 or paragraph 43, wherein the controller circuitry is configured in combination with the transmitter circuitry and the receiver circuitry
to configure one or more of the conditions for triggering the handover to the target infrastructure equipment based on a measured signal quality of one or more reference signals received by the communications device from the target infrastructure equipment and a measured speed of the communications device relative to the target infrastructure equipment, and
to configure one or more of the conditions for triggering the handover to the target relay communications device based on a measured signal quality of one or more reference signals received by the communications device from the target relay communications device and a measured speed of the communications device relative to the target relay communications device.

Paragraph 45. A source infrastructure equipment according to any of paragraphs 42 to 44, wherein the controller circuitry is configured in combination with the transmitter circuitry and the receiver circuitry
to configure one or more of the conditions for triggering the handover to the target infrastructure equipment based on a measured signal quality of one or more reference signals received by the communications device from the target infrastructure equipment and an indication of whether or not the communications device is in the same or different coverage area as the target relay communications device, and
to configure one or more of the conditions for triggering the handover to the target relay communications device based on a measured signal quality of one or more reference signals received by the communications device from the target relay communications device and an indication of whether or not the communications device is in the same or different coverage area as the target relay communications device.

Paragraph 46. A source infrastructure equipment according to any of paragraphs 42 to 45, wherein the controller circuitry is configured in combination with the transmitter circuitry and the receiver circuitry
to configure one or more of the conditions for triggering the handover to the target infrastructure equipment based on a comparison of a measured signal quality of one or more reference signals received from the target infrastructure equipment and the target relay communications device, and
to configure one or more of the conditions for triggering the handover to the target relay communications device based on a comparison of a measured signal quality of one or more reference signals received from the target infrastructure equipment and the target relay communications device.

Paragraph 47. A source infrastructure equipment according to any of paragraphs 42 to 46, wherein the controller circuitry is configured in combination with the transmitter circuitry and the receiver circuitry
to configure one or more execution conditions for triggering an initiation of the handover to the target infrastructure equipment and one or more execution conditions for triggering an initiation of the handover to the target relay communications device.

Paragraph 48. A source infrastructure equipment according to paragraph 47, wherein the controller circuitry is configured in combination with the transmitter circuitry and the receiver circuitry
to configure one or more evaluation conditions for triggering an evaluation of the one or more execution conditions for the target infrastructure equipment and one or more evaluation conditions for triggering an evaluation of the one or more execution conditions for the target relay communications device.

Paragraph 49. A source infrastructure equipment according to paragraph 47 or paragraph 48, wherein the controller circuitry is configured in combination with the transmitter circuitry and the receiver circuitry
to configure one or more conditional handover, CHO, configuration conditions for triggering a configuration of a conditional handover of the communications device to the target infrastructure equipment or the target relay communications device, and
to receive, from the communications device, an indication that one or more of the CHO configuration conditions for the target infrastructure equipment have been met or an indication that one or more of the CHO configuration conditions for the target relay communications device have been met, and in response,
to configure the one or more CHO configuration conditions for the target infrastructure equipment or the target relay communications device based on the received indication,
to transmit, to the communications device, a configuration for the conditional handover including the execution conditions.

Paragraph 50. A source infrastructure equipment according to paragraph 49, wherein the received indication is a measurement report and the controller circuitry is configured in combination with the transmitter circuitry and the receiver circuitry
to configure the one or more CHO configuration conditions for the target infrastructure equipment or the target relay communications device based on the received measurement report.

Paragraph 51. A source infrastructure equipment according to any of paragraphs 42 to 50, wherein, before handover, the controller circuitry is configured in combination with the transmitter circuitry and the receiver circuitry
to provide a wireless access interface for the communications device to transmit signals to and receive signals from the source infrastructure equipment, the source infrastructure being a source of the handover.

Paragraph 52. A source infrastructure equipment according to paragraph 51, wherein the controller circuitry is configured in combination with the transmitter circuitry and the receiver circuitry
to configure one or more of the conditions for triggering the handover to the target infrastructure equipment and one or more of the conditions for triggering the handover to the target relay communications device based on a measured signal quality of one or more reference signals received by the communications device from the source infrastructure equipment.

Paragraph 53. A source infrastructure equipment according to any of paragraphs 42 to 52, wherein, before handover, the controller circuitry is configured in combination with the transmitter circuitry and the receiver circuitry
to provide a wireless access interface for a source relay communications device to transmit signals to and receive signals from the source infrastructure equipment, wherein the source relay communications device provides a wireless access interface for the communications device to transmit signals to and receive signals from the source infrastructure equipment via the source relay communications device, the source relay communications device being a source of the handover.

Paragraph 54. A source infrastructure equipment according to paragraph 53, wherein the controller circuitry is configured in combination with the transmitter circuitry and the receiver circuitry
to configure one or more of the conditions for triggering the handover to the target infrastructure equipment and one or more of the conditions for triggering the handover to the target relay communications device based on a measured signal quality of one or more reference signals received by the communications device from the source relay communications device.

Paragraph 55. Circuitry for a communications device operable to transmit and/or to receive signals from a wireless communications network, the circuitry comprising
transmitter circuitry configured to transmit signals,
receiver circuitry configured to receive signals,
controller circuitry, configured in combination with the transmitter circuitry and the receiver circuitry,
to receive, from the wireless communications network, one or more conditions for triggering a handover of the communications device to a target infrastructure equipment of the wireless communications network and one or more conditions for triggering a handover of the communications device to a target communications device configured to relay signals between the communications device and the wireless communications network,
to evaluate the one or more conditions for triggering the handover to the target infrastructure equipment and the one or more conditions for triggering the handover to the target relay communications device, and
to initiate the handover to the target infrastructure equipment or the target relay communications device based on the evaluation of the one or more conditions for triggering the handover to the target infrastructure equipment and the one or more conditions for triggering the handover to the target relay communications device.

Paragraph 56. Circuitry for a source infrastructure equipment of a wireless communications network operable to transmit and/or to receive signals from a communications device, the circuitry comprising
transmitter circuitry configured to transmit signals,
receiver circuitry configured to receive signals,
controller circuitry, configured in combination with the transmitter circuitry and the receiver circuitry,
to configure one or more conditions for triggering a handover of the communications device to a target infrastructure equipment of the wireless communications network and one or more conditions for triggering a handover of the communications device to a target communications device configured to relay signals between the communications device and the wireless communications network,
to transmit, to the communications device, the one or more conditions for triggering the handover to the target infrastructure equipment and the one or more conditions for triggering the handover to the target relay communications device.

Paragraph 57. A wireless communications network comprising a communications device according to paragraph 28 and a source infrastructure equipment according to paragraph 42.

Paragraph 58. A computer program comprising instructions which, when loaded onto a computer, cause the computer to perform a method according to any of paragraphs 1 to 41.

Paragraph 59. A non-transitory computer-readable storage medium storing a computer program according to paragraph 58.

### REFERENCES

[1] RP-182090, “Revised SID: Study on NR Industrial Internet of Things (IoT),” 3GPP RAN #81.
[2] Holma H. and Toskala A, “LTE for UMTS OFDMA and SC-FDMA based radio access”, John Wiley and Sons, 2009.

1. A method of operating a communications device to transmit and/or to receive signals from a wireless communications network, the method comprising
receiving, by the communications device from the wireless communications network, one or more conditions for triggering a handover of the communications device to a target infrastructure equipment of the wireless communications network and one or more conditions for triggering a handover of the communications device to a target communications device configured to relay signals between the communications device and the wireless communications network,
evaluating the one or more conditions for triggering the handover to the target infrastructure equipment and the one or more conditions for triggering the handover to the target relay communications device, and
initiating the handover to the target infrastructure equipment or the target relay communications device based on the evaluation of the one or more conditions for triggering the handover to the target infrastructure equipment and the one or more conditions for triggering the handover to the target relay communications device.

2. A method according to claim 1, wherein the initiating the handover to the target infrastructure equipment or the target relay communications device based on the evaluation of the one or more conditions for triggering the handover to the target infrastructure equipment and the one or more conditions for triggering the handover to the target relay communications device comprises either
determining that one or more of the conditions for triggering the handover to the target infrastructure equipment have been met and, in response, initiating the handover to the target infrastructure equipment, or
determining that one or more of the conditions for triggering the handover to the target relay communications device have been met and, in response, initiating the handover to the target relay communications device.

3. A method according to claim 1, wherein one or more of the conditions for triggering the handover to the target infrastructure equipment are based on a measured signal quality of one or more reference signals received by the communications device from the target infrastructure equipment and a measured absolute speed of the communications device, and
one or more of the conditions for triggering the handover to the target relay communications device are based on a measured signal quality of one or more reference signals received by the communications device from the target relay communications device and the measured absolute speed of the communications device.

4. A method according to claim 1, one or more of the conditions for triggering the handover to the target infrastructure equipment are based on a measured signal quality of one or more reference signals received by the communications device from the target infrastructure equipment and a measured speed of the communications device relative to the target infrastructure equipment, and
one or more of the conditions for triggering the handover to the target relay communications device are based on a measured signal quality of one or more reference signals received by the communications device from the target relay communications device and a measured speed of the communications device relative to the target relay communications device.

5. A method according to claim 1, wherein one or more of the conditions for triggering the handover to the target infrastructure equipment are based on a measured signal quality of one or more reference signals received by the communications device from the target infrastructure equipment and an indication of whether or not the communications device is in the same or different coverage area as the target relay communications device, and
one or more of the conditions for triggering the handover to the target relay communications device are based on a measured signal quality of one or more reference signals received by the communications device from the target relay communications device and an indication of whether or not the communications device is in the same or different coverage area as the target relay communications device.

6. A method according to claim 1, wherein one or more of the conditions for triggering the handover to the target infrastructure equipment are based on a comparison of a measured signal quality of one or more reference signals received from the target infrastructure equipment and the target relay communications device and
one or more of the conditions for triggering the handover to the target relay communications device are based on a comparison of a measured signal quality of one or more reference signals received from the target infrastructure equipment and the target relay communications device.

7. A method according to claim 1, wherein the evaluating the one or more conditions for triggering the handover to the target infrastructure equipment and the one or more conditions for triggering the handover to the target relay communications device comprises
identifying, from among the one or more conditions for triggering the handover to the target infrastructure equipment, one or more execution conditions for triggering the initiation of the handover to the target infrastructure equipment and one or more execution conditions for triggering the initiation of the handover to the target relay communications device, and
determining that one or more of the execution conditions for the target infrastructure equipment or the target relay communications device have been met and, in response, initiating the handover to the target infrastructure equipment or the target relay communications device.

8. A method according to claim 7, wherein the evaluating the one or more conditions for triggering the handover to the target infrastructure equipment and the one or more conditions for triggering the handover to the target relay communications device comprises
identifying, from among the one or more conditions for triggering the handover to the target relay communications device, one or more evaluation conditions for triggering an evaluation of the one or more execution conditions for the target infrastructure equipment and one or more evaluation conditions for triggering an evaluation of the one or more execution conditions for the target relay communications device,
determining that one or more of the evaluation conditions for the target infrastructure have been met and, in response, evaluating the one or more execution conditions for the target infrastructure equipment, and/or
determining that one or more of the evaluation conditions for the target relay communications device have been met and, in response, evaluating the one or more execution conditions for the target relay communications device.

9. A method according to claim 7, wherein the evaluating the one or more conditions for triggering the handover to the target infrastructure equipment and the one or more conditions for triggering the handover to the target relay communications device comprises
identifying, from among the one or more conditions for triggering the handover to the target relay communications device, one or more conditional handover, CHO, configuration conditions for triggering a configuration of a conditional handover of the communications device to the target infrastructure equipment or the target relay communications device,
determining that one or more of the CHO configuration conditions for the target infrastructure equipment have been met and, in response, transmitting, to the wireless communications network, an indication that one or more of the CHO configuration conditions for the target infrastructure equipment have been met, and/or
determining that one or more of the CHO configuration conditions for the target relay communications device have been met and, in response, transmitting, to the wireless communications network, an indication that one or more of the CHO configuration conditions for the target relay communications device have been met.

10. A method according to claim 9, wherein the indication that one or more of the CHO configuration conditions for the target infrastructure equipment or the target relay communications device have been met is a measurement report and the method comprises
receiving, from the wireless communications network in response to the transmission of the measurement report, a configuration of a conditional handover to the target infrastructure equipment or target relay communications device including the execution conditions for the target infrastructure equipment or the target relay communications device.

11. A method according to claim 1, wherein, before handover, a source infrastructure equipment of the wireless communications network provides a wireless access interface for the communications device to transmit signals to and receive signals from the source infrastructure equipment, the source infrastructure being a source of the handover.

12. A method according to claim 11, wherein the one or more of the conditions for triggering the handover to the target infrastructure equipment and the one or more conditions for triggering the handover to the target relay communications device include one or more conditions based on a measured signal quality of one or more reference signals received from the source infrastructure equipment.

13. A method according to claim 1, wherein, before handover, a source infrastructure equipment of the wireless communications network provides a wireless access interface for a source relay communications device to transmit signals to and receive signals from the source infrastructure equipment, wherein the source relay communications device provides a wireless access interface for the communications device to transmit signals to and receive signals from the source infrastructure equipment via the source relay communications device, the source relay communications device being a source of the handover.

14. A method according to claim 13, wherein the one or more of the conditions for triggering the handover to the target infrastructure equipment and the one or more conditions for triggering the handover to the target relay communications device include one or more conditions based on a measured signal quality of one or more reference signals received from the source relay communications device.

15. A method of operating a source infrastructure equipment of a wireless communications network to transmit and/or to receive signals from a communications device, the method comprising
configuring, by the source infrastructure equipment, one or more conditions for triggering a handover of the communications device to a target infrastructure equipment of the wireless communications network and one or more conditions for triggering a handover of the communications device to a target communications device configured to relay signals between the communications device and the wireless communications network,
transmitting, by the source infrastructure equipment to the communications device, the one or more conditions for triggering the handover to the target infrastructure equipment and the one or more conditions for triggering the handover to the target relay communications device.

16. A method according to claim 15, wherein the source infrastructure equipment configures one or more of the conditions for triggering the handover to the target infrastructure equipment based on a measured signal quality of one or more reference signals received by the communications device from the target infrastructure equipment and a measured absolute speed of the communications device, and the source infrastructure equipment configures one or more of the conditions for triggering the handover to the target relay communications device based on a measured signal quality of one or more reference signals received by the communications device from the target relay communications device and the measured absolute speed of the communications device.

17. A method according to claim 15, wherein the source infrastructure equipment configures one or more of the conditions for triggering the handover to the target infrastructure equipment based on a measured signal quality of one or more reference signals received by the communications device from the target infrastructure equipment and a measured speed of the communications device relative to the target infrastructure equipment, and the source infrastructure equipment configures one or more of the conditions for triggering the handover to the target relay communications device based on a measured signal quality of one or more reference signals received by the communications device from the target relay communications device and a measured speed of the communications device relative to the target relay communications device.

18. A method according to claim 15, wherein the source infrastructure equipment configures one or more of the conditions for triggering the handover to the target infrastructure equipment based on a measured signal quality of one or more reference signals received by the communications device from the target infrastructure equipment and an indication of whether or not the communications device is in the same or different coverage area as the target relay communications device, and the source infrastructure equipment configures one or more of the conditions for triggering the handover to the target relay communications device based on a measured signal quality of one or more reference signals received by the communications device from the target relay communications device and an indication of whether or not the communications device is in the same or different coverage area as the target relay communications device.

19.-54. (canceled)

55. Circuitry for a communications device operable to transmit and/or to receive signals from a wireless communications network, the circuitry comprising
transmitter circuitry configured to transmit signals,
receiver circuitry configured to receive signals,
controller circuitry, configured in combination with the transmitter circuitry and the receiver circuitry,
to receive, from the wireless communications network, one or more conditions for triggering a handover of the communications device to a target infrastructure equipment of the wireless communications network and one or more conditions for triggering a handover of the communications device to a target communications device configured to relay signals between the communications device and the wireless communications network,
to evaluate the one or more conditions for triggering the handover to the target infrastructure equipment and the one or more conditions for triggering the handover to the target relay communications device, and
to initiate the handover to the target infrastructure equipment or the target relay communications device based on the evaluation of the one or more conditions for triggering the handover to the target infrastructure equipment and the one or more conditions for triggering the handover to the target relay communications device.

56. Circuitry for a source infrastructure equipment of a wireless communications network operable to transmit and/or to receive signals from a communications device, the circuitry comprising
transmitter circuitry configured to transmit signals,
receiver circuitry configured to receive signals,
controller circuitry, configured in combination with the transmitter circuitry and the receiver circuitry,
to configure one or more conditions for triggering a handover of the communications device to a target infrastructure equipment of the wireless communications network and one or more conditions for triggering a handover of the communications device to a target communications device configured to relay signals between the communications device and the wireless communications network,
to transmit, to the communications device, the one or more conditions for triggering the handover to the target infrastructure equipment and the one or more conditions for triggering the handover to the target relay communications device.

57.-59. (canceled)
